(19) United States
(12) Patent Application Publication
(10) Pub. No.: US 2004/0015605 A1
(43) Pub. Date: Jan. 22, 2004

(54) Method, computer system and computer system network

(76) Inventors: Petros Andreas Demetriades, London (GB); Todd Howard Morgan, London (GB); Simon Patterson, London (GB); David Ravech, London (GB); Demetrios Zoppos, London (GB)

Correspondence Address: David I Roche, Baker & McKenzie, 130 E Randolph Drive, Chicago, IL, 60601, US

(21) Appl. No.: 10/332,319

(22) PCT Filed: Jul. 6, 2001
(86) PCT No.: PCT/GB01/03048

(30) Foreign Application Priority Data
Jul. 7, 2000 (GB) 00 16822.9
Dec. 22, 2000 (GB) 00 31545.7

(51) Int. Cl. G06F 15/173

(52) U.S. Cl. 709/238

(57) ABSTRACT

A computer system for providing an integrated representation of routes in a transport system is disclosed. The computer system comprises a multiplicity of connectable stations. Data is obtained from a plurality of transport providers. The computer system includes a processing unit, an interface unit for communication with the processing unit, and a memory unit. The computer system is configured to store a short term schedule of individual instances of the route legs each route leg corresponding to a directly connectable station pair. A route segment table, each route segment corresponding to an individual instance of said route legs, or combinations of individual instances of said route legs, is derived from the short term schedule.

This is a National Stage application of International PCT Application No. PCT/GB01/03048.

### BACKGROUND AND SUMMARY OF THE INVENTION

The present invention relates to a method, computer system and computer system network configured for automatically generating routing options for a transport system. In particular, but not exclusively, the present invention relates to automatically generating routing options in an air cargo transport system.

While passenger transport systems, such as rail and air transport, utilize technology such as computer-based booking systems to handle and manage passenger movement and capacity, freight transport management systems are significantly less technologically advanced. For example, through Central Reservation Systems (CRSs), airlines offer passenger tickets for sale and travel agents book such tickets. As a result of the lack of technological tools, the air freight industry, for example, labors under significant inefficiencies.

The freight transport industry is typically highly fragmented. For example, in the air freight transport industry carriers (airlines) and forwarders (air freight/cargo capacity brokers) comprise many different and unrelated undertakings. There exists no centralized communications system or booking system for the forwarders to book cargo capacity with the carriers, and this results in a significant latency in the forwarders adjusting to changes to capacity available from the airlines, and to the airlines adjusting to the level of desired capacity by the forwarders. In order to take account of this latency, forwarders tend to block book cargo capacity up to 6 months in advance, such booking often being an overbooking which may result in a significant number of “no-shows” for the carrier. In order to compensate for such overbooking and to mitigate against “no-shows” carriers overbook flights thereby reducing the number of situations where capacity remains unsold. As a result, if more than the anticipated number of forwarders show-up, the carrier has to offload some forwarders. This means that the perceived service offered by the carrier to the forwarders is reduced. Also, as a result of this, forwarders attempt to micro-manage carriers by insisting on guaranteed flight-specific bookings to avoid such situations where their cargo is off-loaded and their customers (shippers) dissatisfied. This results in loss of revenue for the carriers who are also carrying the burden of high fixed costs and asset risks of running aircraft and routes, by way of possible customer dissatisfaction and unused capacity. Conversely, ad hoc bookings may be made to make up for any shortfall in a forwarder's cargo capacity needs. However, ad hoc bookings are also inefficient since it is necessary for a forwarder, or forwarder's agent, to contact many carriers individually, by telephone, fax or e-mail, for example, in order to obtain information on capacity availability and price. Very often, further information such as the type of cargo a carrier is able to carry over a certain route will be required, together with the type of packaging required.

Although existing Electronic Data Interchange (EDI) systems operated by carriers and forwarders typically operate under established EDI conventions and protocols, different versions, data and data structures are utilized. Thus inter-working and high levels of integration are inhibited. EDI is a generic term for one-to-one communication between systems, which relate to just one carrier. Due to the inherent sequential and asynchronous nature of messaging via EDI, there is no single and current database of flight, capacity availability and rating information that can be addressed electronically via a single query. This inhibits the utilization of such EDI systems within individual carriers and forwarders. Furthermore, the conventions are often rigid International standards and so are difficult to change.

In one-to one EDI systems, a request for information has to be sent to each individual carrier's EDI system. A specific query or request for information has to be made, conforming to a format used by a respective EDI system. This results in EDI users having to send a request for the same information many times, once to each carrier's EDI system, in order to obtain information regarding the total service available. Secondly, the request must be in the appropriate format for each EDI system which may require re-formatting of a request for submission to different systems. This takes significant time and effort on behalf of a user. Additionally, different EDI systems support different information, so that not all EDI systems can answer the same query, or provide the required information. A further drawback is that tariff rate changes can only be distributed slowly, even when distributed via fax or e-mail, since they are not available via a central system.

Another drawback is that results from different carrier EDIs cannot be viewed at the same time. The response from different EDI systems is asynchronous, since they are independent of each other. Thus, a user is inhibited from assessing the information as a whole, which makes optimum selection of available services difficult. This is because existing EDI systems are based around messages sent to and from single carriers. Thus, it is extremely difficult to assemble routing options, for example, across carriers using EDI systems. Currently, it is necessary to send sets of messages to carriers regarding the various segments of a desired journey, and to try to assemble a set of flight segments formed from the individual flight segments to form the journey.

Although EDI systems were originally intended for the electronic exchange of data and to avoid manual input of data, they have degraded into mere messaging systems, and do not provide for the efficient interchange of information. The failure of existing EDI systems to fully integrate, version and update data regarding all the different attributes of plural airline transport systems such as schedule, available capacity and price information for review by forwarders, to provide a system to support bookings by forwarders for example, results in the air freight industry laboring under significant inefficiencies. Furthermore, the lack of automated integrated information management systems, provides a barrier to the optimization of routing options and route management, by for example, taking into account aircraft type with regard to capacity and cargo type for a particular route.

Accordingly, the present invention seeks to provide a computer system, a method for configuring a computer system and a network incorporating such a computer system, that addresses, and preferably mitigates, at least one of the problems associated with known EDI based systems for transport systems. Further problems and drawbacks associated with known EDI based systems will become apparent from the following description and drawings, together with further aspects of the present invention.

Particular and preferred aspects of the invention are set out in the accompanying independent and dependent claims. Combinations of features from the dependent claims may be combined with features of the independent claims as appropriate and not merely as explicitly set out in the claims.

In accordance with a first aspect of the invention there is provided a method of configuring a computer system including a processing unit, an interface unit for communication with said processing unit and a memory unit, for providing an integrated representation of routes in a transport system comprising a multiplicity of connectable stations, the routes being derived from data from a plurality of transport providers, the method comprising:

storing a short term schedule of individual instances of route legs each route leg corresponding to a directly connectable station pair; and

deriving a route segment table comprising one or more route segments, each route segment corresponding to an individual instance of said route legs, or a combination of individual instances of said route legs, from said short term schedule.

In accordance with a second aspect of the invention there is provided a computer system for providing an integrated representation of routes in a transport system comprising a multiplicity of connectable stations, the routes being derived from data from a plurality of transport providers, comprising:

a processing unit;

an interface unit for communication with said processing unit; and

a memory unit;

the computer system configured:

to store a short term schedule of individual instances of said route legs each route leg corresponding to a directly connectable station pair; and

to derive a route segment table each route segment corresponding to an individual instance of said route legs, or a combination of individual instances of said route legs, from said short term schedule.

An advantage of an embodiment in accordance with the first or second aspect of the invention is that the route segment table provides a representation of possible routes (as route segments) within a transport system, derived from data from a plurality of transport providers in an integrated form. Since each route is defined as an instance of a route leg or combination of instances of route legs, routes are defined for a particular time i.e. instance. Each route comprising a combination of individual route leg instances preferably consists of route legs which are associated with the same transport service, such as the same vehicle or route number.

Preferably, data representative of attributes of the route legs is stored in the route segment table. The attributes may include a conveyance capacity associated with each segment. Advantageously, since the information is held centrally in the route segment table, a user can search the table and establish the availability of routes and preferably associated attributes quickly and efficiently without the transport provider being consulted first. That is to say, a computer system in accordance with the invention provides a service quite different to a simple broker system where a user request would be sent to each of the transport providers, each returning a response with the responses then being communicated to the user. Further, deriving the route segment table means user searches can be handled quickly and efficiently in real time. Without the route segment table, laborious searches would have to be made through a multiplicity of data tables.

The route segment table includes an origin and destination pair for each route segment. For segments comprising an individual route leg, the origin and destination pair correspond to the origin and destination stations for that individual route leg. However, for route segments comprising more than one route leg, the origin and destination pair for each route segment comprises the origin station of the first route leg of the route segment and the destination station of the last route leg of the route segment.

Transport providers may provide long term schedules specifying the route legs for a whole season, such as in a train time table for instance. Alternatively, transport providers may provide short term schedules specifying the actual instances (operational schedule) of route legs. Advantageously, in accordance with an embodiment of the invention the system is configured to handle schedule data in either form. Scheduling may be for flight routes, truck routes or routes relating to other vehicles used in the transport system.

In a preferred embodiment, the system is configured to receive and update data from the transport providers. The system may be further configured to initiate and send an update request message to the transport provider as a data update poll. Advantageously, the entries in tables in the memory unit of the system are kept up-to-date.

In accordance with a third aspect of the invention there is provided a method for operating a computer system including a processing unit, an interface unit for communication with said processing unit and a memory unit, for automatically generating route options for a transport system including a plurality of transport providers and including a multiplicity of connectable stations, wherein:

said memory unit comprises a route segment table including one or more route segments corresponding to an individual instance of a route leg, or a combination of individual instances of route legs, each said route leg corresponding to a directly connectable station pair of said transport system;

said method comprising generating one or more route options responsive to a route search request specifying a journey having an origin and destination station pair, each route option comprising a route segment having an origin and destination station pair specified in said route search request and selected from said route segment table; and

storing said one or more route options in a segment set list in said memory unit.

In accordance with a fourth aspect of the invention, there is provided a computer system for automatically generating route options for a transport system including a multiplicity of connectable stations and a plurality of transport providers, the computer system including:

a processing unit;

an interface unit for communication with said processing unit; and

a memory unit comprising a route segment table including one or more route segments corresponding to an individual instance of a route leg, or a combination of individual instances of route legs, each said route leg corresponding to a directly connectable station pair of said transport system;

the computer system configured to:

receive a route search request specifying a journey having an origin and destination pair;

generate one or more route options responsive to said route search request, each route option comprising a route segment having an origin and destination station pair specified in said route search request; and

store said one or more route options in a segment set list in said memory unit.

The journeys may be specified by way of stations corresponding to specific transport depots, for example in an air transport system stations may correspond to airports. Optionally or additionally, journeys may be specified by way of a region such as a city associated with one or more stations.

Aspects of the present invention provide for the integration, handling and management of information relating to different attributes of a transport system in a centralized process and apparatus. Information relating to different aspects of a transport system may be automatically combined to create a list of one or more route options meeting the journey origin and destination stations and other route search request criteria originating from a potential user of the transport system, e.g. a forwarder.

The transport system data is divided up into route segments, each route segment corresponding to an origin station and destination station pair which are preferably connected by the use of a single vehicle. That is to say, in a journey between the origin and destination stations of a route segment the same vehicle is used, and there is no transfer of cargo from one vehicle to another vehicle within the journey. The route segments are derived from individual, or a combination of individual, route legs. Each route leg corresponds to an origin and destination pair which are directly connectable or consecutive origin/destination station pairs. That is to say, a route leg has no intermediate stations between the origin and destination stations. A route segment comprising a combination of route legs has an origin station corresponding to a first route leg in the combination, and a destination station corresponding to the last route leg in the combination.

Additionally, an operator of a transport system, or a part thereof, such as an airline, railway company or shipping line, may modify available route legs by creating new ones or deleting old ones which can then immediately be used in the creation of routing options, without having to modify all possible routing options utilizing such new or old route legs station pairs in accordance with the changes. Thus old or unprofitable routes can easily be deleted, and new routes added.

In a preferred embodiment, an origin and destination station pair for a requested journey are compared with a route table comprising permissible origin/destination station pairs, in order to determine a permissible routing option. Checking the list of routing options against a list of permissible routes provides a carrier, e.g. an airline, with the ability to set up permissible routes which they wish to market and against which requested journey origin and destination station pairs may be automatically checked. When deriving the one or more route options from said route segment table, only route segments for carriers marketing a route corresponding to the requested journey origin destination station pair are utilized. This reduces processing and an originator of the route search request (forwarder) has only those route options which a carrier wishes to market, returned to them.

In one embodiment the route table is used when deriving the route segment table, so that route segments are only created for routes which are permissible. Advantageously, this reduces the size of the route segment table and required storage space, consequently increasing search speeds.

The permissible route options may then be referred back to the originator of the route search request e.g. a forwarder, to allow them to view the list and decide which routing option most meets their requirements.

Typically, one or more consecutive route legs define a route segment. Such a route segment comprises route legs which have some form of association with each other. For example, the same vehicle may be used throughout the segment or in an air cargo system, the route legs making up the route segment may be part of the same flight. In one embodiment of the invention route legs are only combined to form route segments in the route segment table if the route legs have the same route identifier, for example the same flight number. By constructing route segments in this way, the system can handle data from different transport providers. In an air cargo system, some transport providers assign a single flight number to a flight comprising several legs whereas others assign a single flight number to each leg.

Preferably, two or more route segments of the route segment table may be concatenated to form a route option having an origin and destination station pair which correspond to the route search request. In an embodiment which has an attribute associated with each route segment, only route segments which each satisfy the route search request are concatenated. For example, if a search request specifies particular cargo dimensions or a particular container for holding loose cargo (a unitized loading device), only segments which have an associated compatibility entry specifying that the dimensions or unitized loading device are compatible with the leg will be returned.

Yet more preferably, the memory unit stores a transfer set table comprising a plurality of transfer set records, each associated with an origin and destination station pair. Each transfer set record includes one or more entries representative of one or more permissible transfer point stations between route segments for a route between an associated origin and destination station pair. Thus, it is possible for a carrier to set up a table for restricting the number of transfers between vehicles that can occur over any created route. Also the carrier can prevent certain journeys from being returned by not specifying transfer points that make up the journey. In particular, the transfer set table may be linked to the route table such that the transfer set records are each associated with a permissible route. Thus, a carrier may limit the transfers and the transfer stations in accordance with the facilities that the carrier has at that transfer station for the transfer of cargo between vehicles. This is of significant importance where the cargo comprises some form of fragility, such as perishable cargo (e.g. fruit and vegetables). A carrier having a transfer station without suitable refrigeration units may wish to restrict the transfer of such perishable cargo at stations which do not have such refrigeration facilities. The transfer set table may be used together with the route table when deriving the route segment table, again reducing the size of the route segment table and increasing search speeds.

Suitably, the route search request includes a parameter representative of a maximum number of,transfer points in a route between the origin/destination pair to derive routing options which comprise no more transfer points than the maximum number. Thus, a user of the transport system may specify in advance the maximum number of transfer points they wish to have in any of the routing options created for them. This gives the forwarder the opportunity to request a search for routing options which can take account of the nature of the forwarder's intended cargo. That is to say, if a forwarder is wishing to purchase conveyance capacity for a fragile cargo, they may wish to avoid transfer points, or keep them to a minimum number, in order to reduce the likelihood of damage to the cargo and loss through theft by reducing the number of transfers between vehicles.

Structuring the information in this way provides a high degree of flexibility for creating route leg and segment combinations to meet search request criteria.

Advantageously, data representative of respective attributes of said route legs are received from said transport providers, said data being included in said route segment table. Thus, a route search request can include a parameter representative of an attribute such that one or more routing options may be derived wherein the origin and destination pair are associated with the attribute. Thus, the forwarder may request origin and destination station pairs for which the routes will have certain attributes, for example departure time and arrival time for a journey between the origin and destination station pair, and conveyance capacity, for example. Separate tables are set up comprising one or more attributes of the transport system and which are used when deriving the segment set list. An operator of a transport system, for example a carrier, may then modify respective attribute tables to reflect the services they wish to offer, without having to modify a large table such as the segment set table. This reduces the complexity and processing necessary for updating the data tables.

In accordance with a fifth aspect of the present invention, there is provided a client computer system configured for remote communication with a computer system as described in the foregoing paragraphs. The client computer system comprises:

a processing unit;

an interface unit for communication with said processing unit;

a memory unit; and

a display means for displaying information to a user of said client computer system;

said processing unit comprising a user interface mechanism configured to receive said search request input via said interface unit from said user, and to communicate said search request to said computer system for processing thereby.

In a preferred embodiment, the client computer system comprises a user interface mechanism configured to provide a graphical representation of the route segment set list, the user interface mechanism being operable to display on a display means a plurality of route options including origin and destination station, departure date, arrival date, available conveyance capacity and price for conveyance arranged in a logical grouping, the user interface mechanism being responsive to a user input to select a displayed route option and to record a user booking of at least a portion of a conveyance capacity of the selected route option.

A sixth aspect of the invention provides a computer system network comprising a plurality of client computer systems and a computer system as described in the foregoing paragraphs.

### BRIEF DESCRIPTION OF THE DRAWINGS

Specific embodiments, in accordance with the present invention, will now be described, by way of example only, with reference to the accompanying drawings, in which:

FIG. 1 schematically illustrates the geographic distribution of airports in an air transport system;

FIG. 2 schematically illustrates an example of a forwarder's cargo booking architecture;

FIG. 3 schematically illustrates the logical location of a data management system in accordance with an embodiment of the present invention;

FIG. 4 schematically illustrates functional aspects and relationships of a data management system in accordance with an embodiment of the present invention;

FIG. 5 schematically illustrates details of a database structure for a data management system in accordance with an embodiment of the present invention;

FIG. 6 is a relationship diagram for establishing a flight segment table;

FIG. 7 schematically illustrates a maximum connection timetable;

FIG. 8 schematically illustrates a minimum connection timetable;

FIG. 9 is a relationship diagram for a carrier marketed route options table and a transfer points table;

FIG. 10 is a flow diagram for the creation of a flight segment table;

FIG. 11 schematically illustrates a network coupled data management system in accordance with an embodiment of the present invention;

FIG. 12 schematically illustrates the logical architecture of a data management system in accordance with an embodiment of the present invention;

FIG. 13 schematically illustrates the physical architecture of a data management system in accordance with an embodiment of the present invention;

FIG. 14 schematically illustrates a computer system workstation;

FIG. 15 schematically illustrates an example of a search for capacity user interface screen;

FIG. 16 is a flow diagram for a dmPerformSearch stored procedure in accordance with an embodiment of the invention;

FIG. 17 is a flow diagram for a dmFltLegSet stored procedure in accordance with an embodiment of the invention;

FIG. 18 is a flow diagram for a Carrier Search function in accordance with an embodiment of the invention;

FIG. 19 is a flow diagram for a Unitized Search function in accordance with an embodiment of the invention;

FIG. 20 schematically illustrates the architecture of a particularly suitable data management system in accordance with an embodiment of the present invention;

FIG. 21 illustrates an example of leg-based capacity updates;

FIG. 22 illustrates an example of a polling window; and

FIG. 23 is a schematic illustration of capacity update messages.

### DETAILED DESCRIPTION OF THE INVENTION

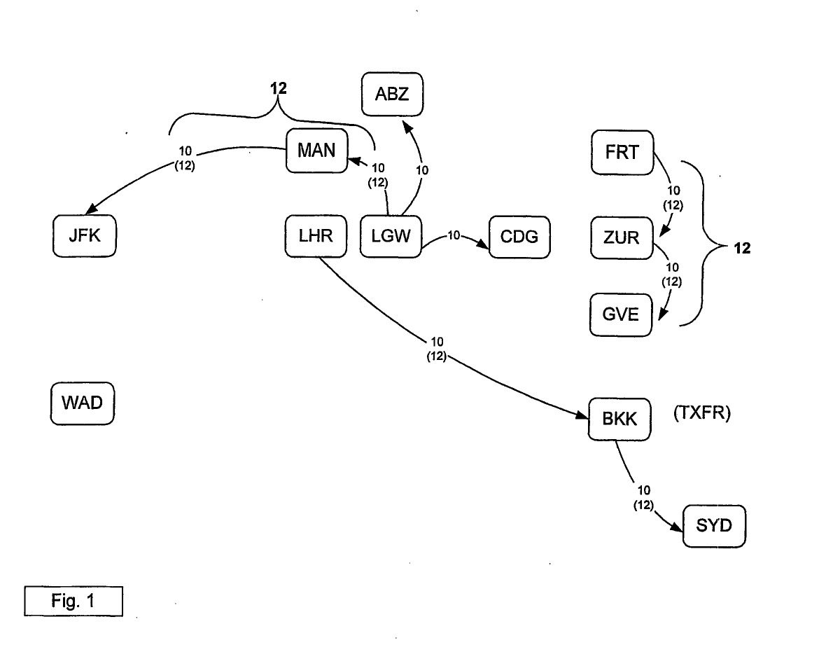

Referring now to FIG. 1, there is illustrated an example of a transport system having a plurality of connectable stations. In the particular example of FIG. 1, the transport system is an air transport system in which the connectable stations are airports. The airports are geographically distributed substantially as shown in FIG. 1 and are referred to using the International Air Transport Association (IATA) codes. In an air transport system a number of carriers, airlines, provide flights between airports thereby connecting stations within the transport system. A direct connection between two consecutive airports, is termed a flight leg, referenced 10 in FIG. 1. Flight legs represent the lowest level of connection within an air transport system and may be considered to comprise a “wheels up-wheels down” sequence. A single flight leg or combination of flight legs forming part of the same flight, e.g. having the same flight number, are termed flight segments, referenced 12 in FIG. 1. For individual single flight legs within a flight segment, reference 12 is placed in brackets indicating that the single flight leg forms a part of a flight segment. Generally, a flight segment is bounded by transfer points but may include any number of stopovers and even different aircraft.

A route between London Gatwick (LGW) and John F. Kennedy (JFK) airports shown in FIG. 1 includes a stopover, for re-fuelling and/or on-load or off-load of cargo, at Manchester (MAN) airport. Additionally, there are connections between LGW and MAN, and MAN and JFK. Each connection, LGW/MAN and MAN/JFK is a flight segment.

The route between LGW and JFK is also a flight segment and comprises flight legs LGW/MAN and MAN/JFK. Freight on flight segment LGW/MAN may connect with the flight segment LGW/JFK at MAN, thereby using flight leg MAN/JFK of flight segment LGW/JFK to complete a route between LGW and JFK.

For the journey shown from London Heathrow (LHR) to Sydney (SYD) via Bangkok (BKK), two flight segments 10 are shown. These are not flight legs for the journey LHR to SYD, because a transfer (TXFR) between flights occurs at BKK, and thus the journey LHR to SYD is not a single flight segment. Additionally, airports may be connected by road or rail. For example, a truck may be booked to transport cargo from Zurich (ZUR) to Geneva (GVE) for transferring onto a flight to another airport, if no suitable flight is available into Geneva airport.

Airlines often operate primarily within geographic areas and do not offer service between all airports. Restrictions are generally due to the service locations of the aircraft for a particular airline, as well as market and business plans of the airline. In particular, many airlines are state-owned, controlled or strongly linked with the state, which often restricts the operation of the airline.

In air cargo transport systems there are a number of players. There are the carriers who provide cargo capacity on flights; the forwarders who book cargo capacity from carriers; and integrators who combine the function of both carrier and forwarder into a vertically integrated service.

Carriers provide air cargo capacity within aircraft. In general, they do not interface directly with shippers wishing to have cargo transported (or the receivers of air cargo), but distribute cargo capacity via freight forwarders who function as their agents or brokers.

Carriers may be divided up into three main types. The first type includes carriers who provide both passenger and cargo service. Typically, the air cargo service comprises the excess belly-hold space on passenger aircraft, although there are a number of passenger airlines that operate dedicated freighter aircraft. Some of these passenger airlines also operate so-called “combis” that have some of the main-deck seats of the passenger cabin removed in order to give additional cargo capacity.

A second type of carrier is the cargo only carrier. These are carriers dedicated to the transportation of cargo through the operation of an all-freighter fleet and comprise freight operator companies such as CargoLux and Polar. In most cases, the carriers operate regular or semi-regular services and distribute their cargo capacity through freight forwarders. In some cases, the freighter operators will offer specially arranged or charter flights on an as-needed basis.

A third type of carrier is the so-called “private label” carrier. Such carriers, for example Atlas, promote the outsourcing of freighters by operating aircraft on behalf of other carriers who contract for the full freighter including the pilot. Optionally, the private label carriers will sub-divide an aircraft on behalf of two or more conventional carriers.

Freight forwarders, more commonly referred to as “forwarders”, are brokers of air cargo capacity in the sense that they principally buy capacity on behalf of shippers, and manage the logistics and customer documentation on behalf of the shippers. Generally, forwarders do not own their own aircraft, and where they do they may be considered to be integrators, as described later.

The forwarder industry is highly fragmented with in excess of 10,000 such undertakings throughout the world. Indeed, there are estimated to be around 1000 forwarders in the UK alone. Although forwarders are generally multi-modal in that they ship via sea, road and rail in addition to air cargo, a very significant proportion of their activities and resources are directed to the air cargo market.

There is a third type of player in the air cargo transport environment which has only recently become significant. This player is known as an Integrator. Integrators own their own aircraft and interface with customers through an extensive retail/ground network to provide the forwarder function. The four main players are currently Fedex, UPS, DHL and TNT, who represent a vertical integration of the airline and forwarder functions.

Within the air transport system, certain locations are known as “hubs”. Hubs are the main entrances or portals to the air transport system and are distributed throughout the main territories of the air transport system. Typically, cargo is transshipped between aircraft at hubs. A hub is usually a carrier base, where the carrier's operational equipment is stored, maintained and serviced. Forwarders generally have their infrastructure based around one or more hubs.

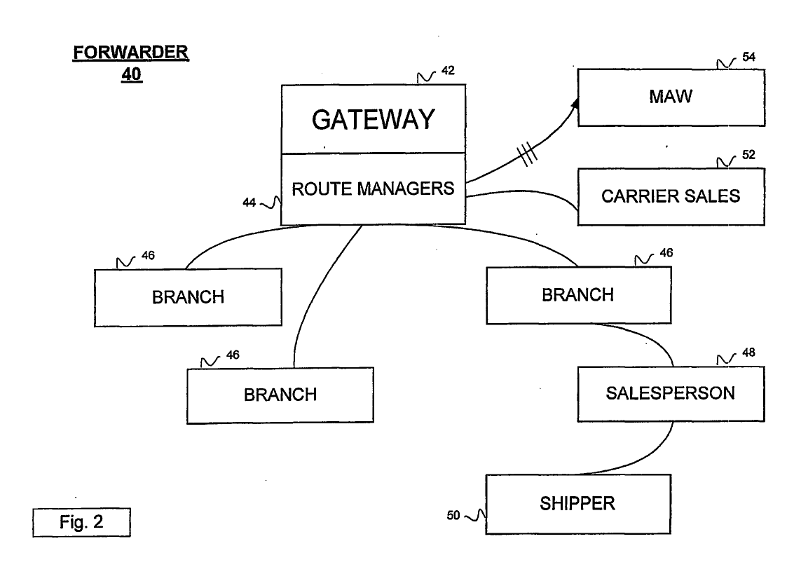

The existing forwarder infrastructure for making cargo bookings will now be described with reference to FIG. 2.

The gateway 42 is controlled and managed by a combination of a carrier route manager 44 and a forwarder gateway manager. The carrier route manager receives cargo capacity requests from a forwarder gateway manager who in turn receives cargo capacity requests from respective forwarder branches 46, who have been contacted by a sales person 48 to provide cargo capacity on behalf of a shipper 50, or direct from a shipper. Currently, requests for cargo capacity made to the carrier route manager from the forwarder gateway manager are made via telephone, fax or e-mail.

Typically, an individual sales person 48, or a branch 46, is provided with cargo capacity targets for sale to shippers. As cargo is received from shippers 50 and forwarded to the forwarder gateway manager, the forwarder gateway manager seeks to balance the cargo capacity requirements with the capacity he has pre-booked or can negotiate with the carriers. Separate cargo packages from shippers are consolidated at gateway 42 for onward carriage. Optionally, the branch or salesperson consolidates shipments before passing them onto the forwarder gateway manager. The forwarder gateway manager is responsible for negotiating and managing consolidated bookings and regular bookings on a given route or set of routes. They negotiate with the carrier route manager to ensure that adequate cargo capacity has been booked to meet the forwarder organizations consolidation, general cargo or ad hoc requirements. The forwarder gateway manager negotiates by fax, telephone or e-mail with a carrier sales person 52 or the carrier route manager in order to manage the cargo capacity requirements on a daily, weekly, basis, etc, as appropriate. Optionally, the carrier may operate a telephone call center. This can be a substantial challenge, since there can be differences in the daily (including hourly), weekly and seasonal demand for air cargo capacity. Such differences are driven by consumer and industrial buying patterns, shipper manufacturing configurations, scheduling and shipping approaches, such as back consolidation or just in time shipping. For example, even a relatively minor breakdown at a manufacturing facility of a shipper with substantial volume on a given route can create a backlog of goods and throw the market into imbalance for weeks. The demand variances are also complicated by global macro-economic trends such as GDP growth, foreign exchange rates and labor rates which can have a significant impact on the directional focus of any given route and by micro-economic conditions such as labor strikes.

The forwarder gateway manager makes two types of bookings, permanent and ad hoc bookings. Permanent bookings are long-standing bookings of six months or more allocation of cargo capacity on a given flight. Ad hoc bookings, as their name suggests, are made at the time they are required. They exist outside of the permanent bookings arrangement. The permanent bookings may have different rates in accordance with various factors such day, month, nature of cargo, the route, capacity, etc.

The forwarder gateway manager utilizes the forwarder computer legacy system to analyze the record of all permanent bookings made with the various carriers. The gateway manager then seeks to balance all the difference cargo capacity requirements originating from the branches to best utilize the available permanent booking. Any excess requirement on any particular route would then be achieved by ad hoc bookings. The permanent bookings are made by negotiation with the carrier sales 52, although are generally based upon long-standing expectations and commitments. What is more complex, are the ad hoc bookings in which a forwarder gateway manager has to contact a number of carrier sales 52 in order to determine what cargo capacity over what routes and at what price are available to fulfill the ad hoc requirement. Currently, this is achieved by virtue of telephone calls, fax transmissions and, sometimes, electronic mail. Thus, the forwarder gateway manager has to contact an individual carrier sales person 52 to determine available cargo capacity to meet the ad hoc requirement for that carrier. The forwarder gateway manager has to contact each carrier sales person 52, for each carrier operating at the hub in order to determine what cargo capacity is available. The forwarder gateway manager then has to analyze all the information to determine with which carrier to book the ad hoc capacity. However, it is often the case that the forwarder gateway manager is unable to get an immediate answer from the carrier sales as to available cargo capacity since the carrier sales would have to conduct their own investigations within the carrier to determine what is currently available. This may occur with many of the carriers with sales persons with whom the route manager has requested ad hoc capacity. This introduces a significant latency in the information available to the forwarder gateway manager, and makes the booking of appropriate cargo capacity extremely difficult.

The forwarder gateway manager consolidates the shipments in terms of permanent bookings and ad hoc bookings from the branches at the gateway 42 and transfers the individual house airway bills (HAWB) for each shipment onto a master airway bill (MAWB) pre-allocated by the carrier. The forwarder gateway route manager also organizes and manages shipments into Unit Load Devices (ULD) for transfer to the carrier or may merely provide loose or bulk shipments which will be packaged and unitized by the carrier themselves. ULDs are containers for holding loose cargo. They are of three main types: containers which are enclosures with or without lids; pallets; or igloos which sit on top of a pallet and restrict or constrain the volume of cargo supported by the pallet.

Forwarders may not have contractual penalties applicable for the permanent bookings that they maintain with carriers. As such, there may be no incentive or penalty if the forwarder is a ‘no-show’, or ships less than was booked. The forwarder gateway manager may also alert the carriers sales 52 when a permanent booking or allocation made on behalf of the forwarder is unlikely to be used. When negotiating with the carrier sales 52, the forwarder gateway manager will often haggle over the rates for a particular shipment.

In general, the existing forwarder/carrier interface is very difficult to manage since a plurality of negotiations are necessary and there is a significant latency within those negotiations. Furthermore, there is a low visibility of the availability of cargo capacity and currently there is no electronic or automated integration between the forwarder systems and the carrier legacy systems.

Furthermore, in order to complete a booking, the forwarder gateway manager has to await confirmation of the booking by typically a fax back communication which provides proof to the shipper that a booking for their shipment has been made. The airway bill is then utilized on the basis of this booking and fixed to the shipment. As mentioned above, individual airway bills are appended to a master airway bill 54 for the combined booking made by the forwarder with the carrier.

The carrier sales 52 or route manager 44 labor under significant limitations as to data availability on air cargo capacity within their carrier. The carrier sales 52 and route manager 44 wish to optimize the revenue obtained from their cargo business which would typically require a high level of flexibility in rates and type of cargo in order to fully utilize the capacity. However, at the moment, the carrier sales 52 and route manager 44 just know the weight available on a particular route at any particular moment. This substantially limits the service that they can provide to the carrier.

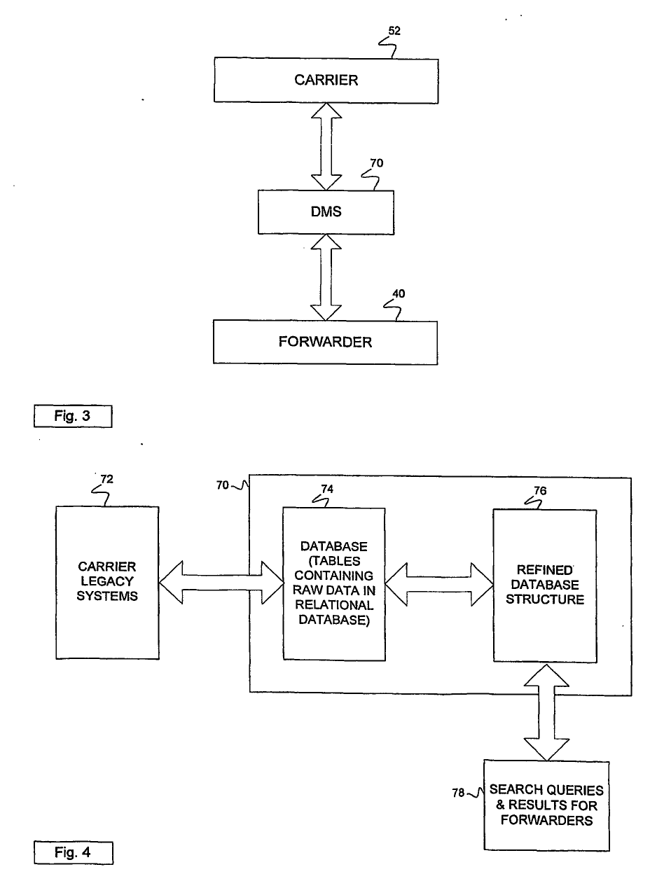

In accordance with an embodiment of the present invention, data management system (DMS) 70 is provided between the carriers sales 52 or route manager 44 and the forwarder (typically the forwarder gateway manager), as illustrated in FIG. 3. The DMS 70 in accordance with the invention provides an interface between the carrier sales 52 and the forwarder 40 in order to enhance the nature of the transactions conducted between them. Suitably, the DMS 70 provides up-to-date, on-line scheduling, including cargo capacity. Additionally, a quote market is available in which buyers of capacity can view data about the price at which a carrier will make capacity available to them to meet their requirements, for example by route, shipment type weight and cargo type. Furthermore, such a DMS system is capable of performing complex searches in order to enable forwarders to input a desired origin/destination airport pair, and a range of search criteria, such as preferred vehicle types, cargo type and shipment type, and then search and display a list of carrier options to meet these criteria. A further enhancement is that the display order may be determined by the customer's prioritization of search criteria (e.g. by placing a priority on preferred carrier relationships, lowest rate, earliest departure or latest arrival). Such prioritization may be by way of a parameter pre-set by a forwarder, or input at the time of searching. Additionally, a reverse market or auction may be conducted by virtue of the DMS 70, in which prospective buyers of capacity can place a request for a quote to a selected set of carriers. Optionally, an auction market may be provided where prospective sellers of capacity, typically carriers, initiate an auction for excess capacity over a particular route with unsold capacity.

The functional aspects of the DMS 70 and their relationship to the carrier and forwarder will now be described with reference to FIG. 4.

DMS 70 contains a relational database including tables comprising raw data received from carrier legacy systems 72. The DMS system derives a refined database structure 76 from the raw data contained in database 74. The refined database structure 76 is configured for efficient searching in response to search queries from forwarders 78. A forwarder submits a search query to the DMS 70 and has returned to it a results table which includes carrier routes conforming to the search query criteria. The tables contained in database 74 are set up such that the data may be easily maintained and updated over a link from the carrier legacy system 72, preferably an automatic update link. Any changes in database 76 caused by updating of database 74 are then effected such that the revised database structure 76 is kept up-to-date, in order to service search queries and provide suitable results to the forwarder's systems 78.

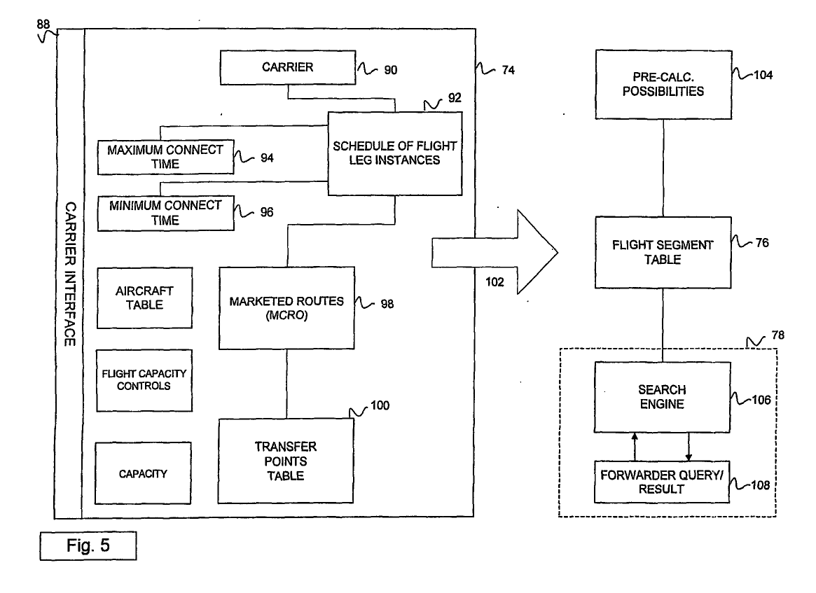

Relational database 74, containing the raw data received from the carriers, will now be described in further detail with reference to FIG. 5. Relational database 74 contains a plurality of data tables. The data is input to the database from the carriers over a carrier interface 88. Optionally, where there is no electronic interface with the carriers, the data may be input by way of keyboard entry by the operator of the DMS system. Database 74 contains a carrier table 90 comprising a list of carriers taking part in the DMS 70 in accordance with the invention. For each carrier entered into the carrier table 90, a series of related tables are stored in the database. At the top level, there is stored an operational schedule table 92 for each carrier. Not all carriers provide an operational schedule, which is for a limited period, for example 2 weeks or 1 month, but instead provide a seasonal schedule which is typically a 3 month or 6 month advance schedule of flights. Schedule table 92 comprises the operational schedule (a short term schedule) provided to the DMS, or as derived from the seasonal schedule (a long term schedule), as appropriate to the particular carrier. The operational schedule table 92 provides a schedule of each flight leg instance for the carrier 90. That is to say, each flight between stations, the origin & destination stations, the time and date of arrival and departure, equipment type and ability to on-load or off-load cargo at each station for the flight are recorded in the operational schedule.

In a preferred embodiment of the invention, a maximum connect time may be defined as a global parameter across the DMS system for all carriers, or on a carrier by carrier basis. Additionally, a minimum connect time table 96 is provided which is related to the operational schedule table 92. The minimum connect time table 96 is a table of the stations included in schedule table 92 together with the minimum transfer times between carrier aircraft at that station.

Optionally, a maximum connect time table 94 is also provided and comprises a table of the stations referred to in the schedule table 92 together with the maximum connection time for transfers between carrier aircraft at that station.

A further table related to the schedule table 92 is the Marketed Carrier Routes Options (MCRO) table 98 (a route table). This table contains the routes marketed by the carrier, together with other relevant information for that route. Related to the carrier's MCRO table 98 is a transfer points table 100. The transfer points table contains a list of the marketed routes, together with the number of transfer point stations allowable for a journey over that route.

At least a part of the data contained in database 74 may be transferred, 102, to a pre-calculation routine 104 which derives the flight segment table 76 from the data in database 74.

Pre-calculation routine 104 creates an instance of every valid combination of flight legs derived from respective operational schedule tables 92. Valid combinations of flight legs are formed in accordance with the examples disclosed in the description of FIG. 1. Namely, that a flight segment is bounded by transfer stations. Any number of flight legs may be combined to form a flight segment.

Referring now to FIG. 1, pre-calculation routine 104 instantiates flight segments LGW-MAN, MAN-JFK and LGW-JFK, showing all possible flight leg combinations. However, only flight segments LHR-BKK and BKK-SYD are instantiated in flight segment table 76, without an instance of LHR-SYD, since BKK is a transfer station. That is to say, cargo is transferred from one aircraft to another at BKK for onward carriage to SYD.

The DMS system also includes a search engine 106 which is coupled to the flight segment table 76 and responds to a search query 108 to search for suitable flights in the flight segment table. The search engine also interrogates other data tables in the DMS system which relate to parameters in the search request and the flight segments. The search engine also returns search results 108 to the forwarder submitting the query.

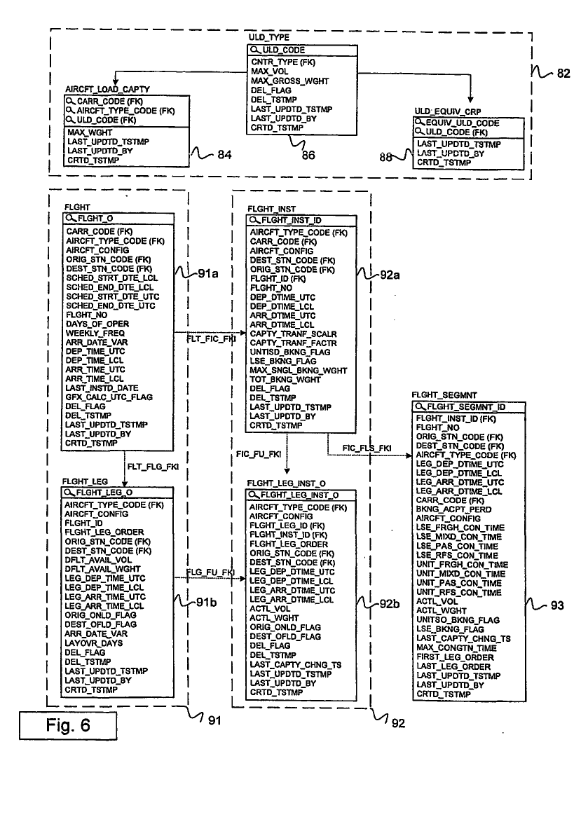

An example of the data provided by a carrier in a seasonal schedule table entry 91 is illustrated in FIG. 6. The entry is represented as a column. Many entries make up the seasonal schedule.

The seasonal schedule entry 91 is divided into two parts, 91a representing a flight and 91b representing a flight leg of the flight represented by 91a. For each flight 91a, there may be one or more flight leg entries 91b respectively corresponding to each flight leg of flight 91a. The flight leg entries 91b are children of flight entry 91a.

Flight entry 91a comprises information characterizing a flight, for example: carrier code (CARR_CODE); aircraft type and configuration codes (AIRCFT_TYPE_CODE) and (AIRCFT_CONFIG) respectively; origin and destination stations for the flight (ORIG_STN_CODE) and (DEST_STN_CODE); the seasonal schedule start and end dates (SCHED_STRT_DTE) and (SCHED_END_DTE) in both local end universal time (i.e. GMT) shown by the extension LCL and UTC respectively; the flight number (FLIGHT_NO), days of operation (DAYS_OF_OPER) and the weekly flight frequency (WEEKLY_FREQ) are also included in the entry; and the arrival and departure times (ARR_TIME) and (DEP_TIME) are given in both local (LCL) and universal time (UTC).

Flight leg entry 91b includes the identity of the flight of which it is a leg, (FLIGHT_ID), and the order of the leg within the flight, (FLIGHT_LEG_ORDER). The leg departure and arrival times (LEG_DEP_TIME) and (LEG_ARR_TIME) are included for both local (LCL) and universal (UTC) time. Also included in flight leg entry 91b is information on the usual cargo capacity for the aircraft type and configuration in terms of weight (DFLT_AVAIL_VOL) and volume (DFLT_AVAIL_WGHT). The flight leg 91b is also identified as allowing cargo to be on-loaded at origin and/or off-loaded at destination by setting flags (ORIG_ONLD_FLAG) and (DEST_OFLD_FLAG) respectively.

The operational schedule 92 is either derived from the seasonal schedule 91 or is supplied directly by the carrier, and an entry for flight instances and flight leg instances are shown labeled 92a and 92b respectively in FIG. 6.

Flight instance entry 92a is a child of flight entry 91a. Flight instance entry 92a contains more detailed information regarding individual flights, i.e. a flight instance. The departure and arrival times are provided by date and time (DEP_DTIME) and (ARR_DTIME) in both local and universal time.

The types of allowable cargo and limits of cargo are included in the fields (UNITSD_BKNG_FLAG) and (LSE_BKNG_FLAG) for indicating whether unitized or loose cargo bookings are allowed, and (MAX_SNGL_BKNG_WGHT) and (TOT_BKNG_WGHT) for the maximum single booking by cargo weight, and the total weight of cargo bookings by a forwarder organization that may be taken. The contents of these fields may be set to default values dependent on the aircraft type and configuration, or by the carrier. The maximum single booking weight limit and total booking weight limit may be set by the operator of the DMS as a system parameter, automatically or manually derived from the default values, for example.

Flight leg instance entry 92b is a child of both flight instance entry 92a and flight leg entry 91b. The flight leg instance entry 92b includes specific details of that flight leg. For example, the leg order (FLGHT_LEG_ORDER), flight instance and flight leg identities (FLGHT_INST_ID) and (FLGHT_LEG_LID), and the actual cargo capacity available by volume (ACTL_VOL) and weight (ACTL_WEHT). Other fields corresponding to fields of flight leg entry 91b and flight instance entry 92 are also included as shown in FIG. 6. The actual cargo capacity available by volume and weight is preferably provided separately to the schedules. For example available capacity data for each route leg instance may be provided by each carrier. Alternatively, carriers may set default values for sets of legs. In a preferred embodiment carriers provide capacity data in a table for each route leg instance and may provide capacity updates.

A flight segment entry 93, corresponding to an entry in a flight segment table, is derived from the flight instance entry 92a and flight leg instance entry 92b. The fields for flight segment entry 93 include the flight number, flight instance identity, origin and destination stations, the carrier code, arrival and departure times and the aircraft configuration. Also included is a field for setting a period prior to flight departure during which no further cargo bookings for the flight segment may be taken (BKNG_ACPT_PERD); this defines a latest booking acceptance time. This field may be set by the DMS operator or be a default period, for example. The available volume and weight of cargo capacity is included in the flight segment entry 93, together with the connection times for different types of cargo for different types of aircraft. The connection time categories are loose (LSE) or unitized (UNIT) freighter (FRGH_CON_TIME), mixed passenger and freighter, (MXD_CON_TIME), passenger (PAS_CON_TIME) or truck (RFS_CON_TIME).

In a preferred embodiment the type of equipment from which the cargo is off-loaded and on to which cargo is to be loaded, determines the connection time. In a preferred embodiment, flight segment entry 93 also includes a maximum connection time (MAX_CONCTN_TIME) which is a system wide parameter and field for (LAST_LEG_ORDER) and (FIRT_LEG_ORDER), respectively identifying the last and first flight leg in the segment.

Also illustrated in FIG. 6 are Unitized Loading Device (ULD) tables 82. Aircraft load capacity table 84 is provided for each aircraft type, identified by AIRCFT_TYPE_CODE(FK), and is maintained by respective carriers having carrier codes CARR_CODE(FK). Each table 84 includes a field ULD_CODE(FK) indicating the ULD type which the identified aircraft can carry.

Table 86, ULD_TYPE, comprises a full list of the ULD types, drawn from what are used in the cargo freight industry.

Table 88, ULD_EQUIV_GRP, maps ULD type codes onto equivalent ULD codes (EQUIV_ULD_CODE), in order to harmonise different ULD types used in the industry to standard types used in the DMS system. For example, different ULD codes may be used in the industry to refer to the same ULD type or different ULD codes may be compatible.

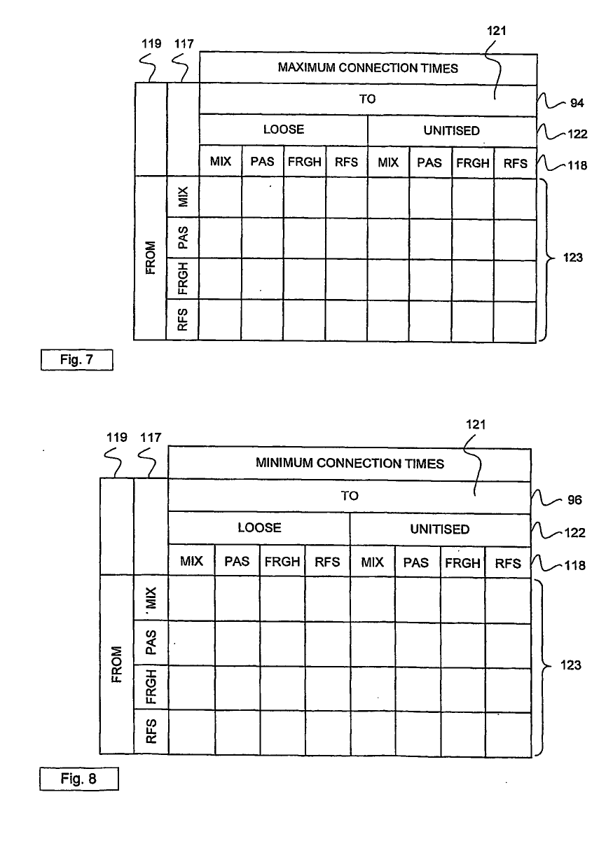

FIG. 7 is an example of a maximum connection time table 94 in accordance with an optional embodiment of the invention and from which the maximum connection time fields for the flight segment table 93 can be populated. The table is in the form of a grid, each type of carrier equipment (117, 118) is represented as being an originating equipment from (119) which cargo is unloaded, and to (121) which cargo is transferred. The grid is split into two repeating parts for loose and unitized cargo 112 respectively. The grid cells 123 each hold a value which represents the maximum connection time for transfers of cargo between the equipment and for the shipment type to which the cell relates.

A maximum connection time table 94 is set up for each carrier, and in a further optional embodiment for each station in the carrier's network at which on-load and off-load of cargo can take place. The maximum connection time table 94 illustrated in FIG. 7 is merely an example, in grid format, of such a table. It is readily recognizable that other logical structures and criteria may be utilized, and embodiments of the invention are not limited to specific examples. For example, it may be the case that the maximum connection time is dependent upon the type of cargo that is being transferred, and therefore the time may vary according to cargo type. An example of a cargo type where maximum connection time may be critical is that of perishable goods, such as food and vegetables. The maximum transfer time for such cargo may be significantly shorter than the maximum transfer time for non-perishable goods such as electronic equipment.

FIG. 8 is an example of a minimum connection time table 96. The minimum connection time table 96 is shown having a similar logical structure to the maximum connection described with reference to FIG. 7, and so no further description will be provided.

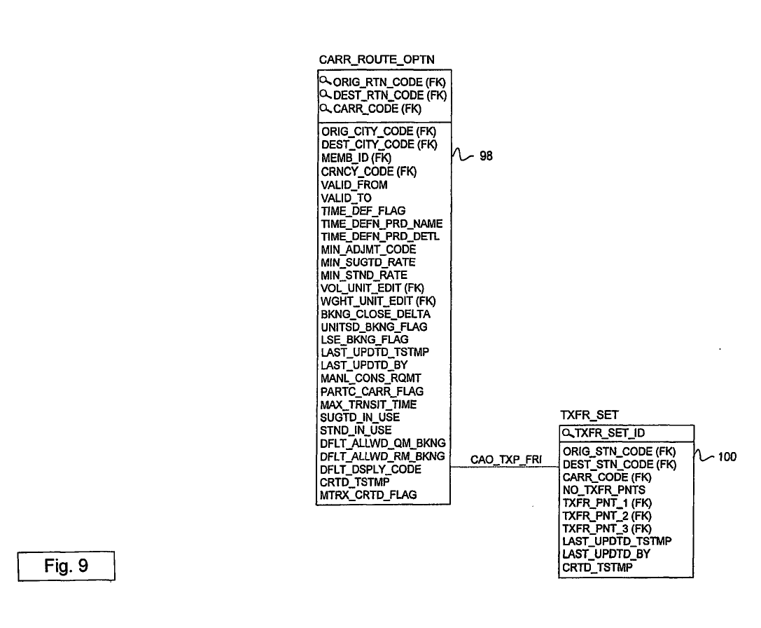

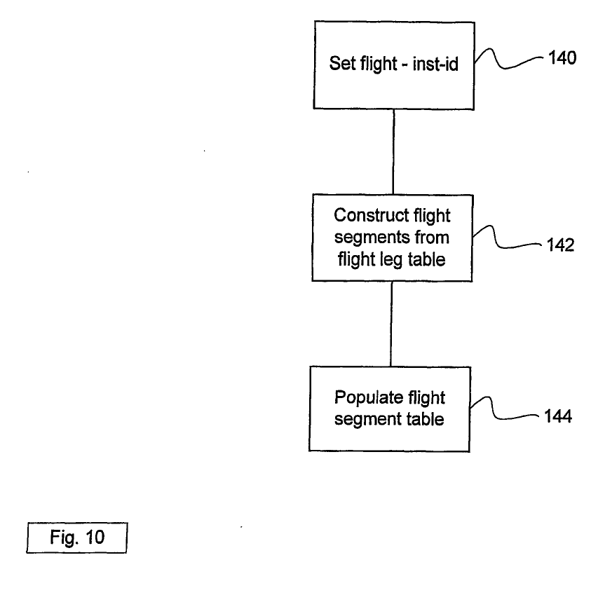

An example of an MCRO table 98 is illustrated in FIG. 9. The MCRO table 98 defines the carrier route options which the carrier wishes to market. To this end the origin station and destination station are defined together with a carrier code, respectively designated ORIG_STN_CODE, DEST_STN_CODE and CARR_CODE. Typically an origin city and destination city are included in MCRO table 98 and are designated ORIG_CITY_CODE and DEST_CITY_CODE. However, designating the origin and destination city is not necessary. Various other fields are available within the MCRO table which relate to DMS parameters which control all management aspects of the DMS and will not be described in detail. However, the carriers are able to define a suggested rate for the carriage of cargo as well as a minimum rate, (MIN_SUGTD_RATE) and (MIN_STND_RATE) for the route. Additionally, there is a unitized and a loose booking flag for indicating the type of cargo the carrier wishes to carry on this route. These flags are represented by the fields UNITSD_BKNG_FLAG and LSE_BKNG_FLAG respectively. A maximum journey time for the route (MAX_TRNSIT_TIME) is also specified. The MCRO table 98 illustrated in FIG. 9 is just for one carrier and one route. Every carrier will define each of their marketed routes by such a table, and it will be evident that the tables need not be structured in the manner illustrated in FIG. 9, but may be formatted in any suitable logical structure.

Also illustrated in FIG. 9 is a transfer set table 100, which is related to the MCRO table 98. The transfer set table 100 is a child of the MCRO table 98. Within the transfer set table is included the origin station code and destination station code of the related carrier routes, together with the carrier code. In the example illustrated in FIG. 9, there are four fields which specify the number of transfer points in a transfer sequence and the sequence of up to 3 transfer points itself for the marketing route. These fields are respectively designated NO_TXF_PNTS, TXFR_PNT_{—}1, TXFR_PNT_{—}2, and TXFR_PNT_{—}3. For each of the fields for which a station may be designated as a transfer point, the appropriate station code is entered into the field. If not all the possible transfer points are used, for example only two stations are to be designated as transfer points, then the field for the third transfer point may be left blank indicating that there is no third transfer point available. Multiple sequences of transfer points (transfer sets) may be specified for a single carrier marketed route.

The transfer set table provides a high level of flexibility for the carrier in terms of the routes they wish to market. It is a relatively simple matter to modify which stations are to be transfer points and whether or not transfers are to be available at all. In this way, the marketed options can be easily updated and modified. Another advantage is that the carrier does not have to define every single available route, but merely the combinations of transfer point stations available. Thus, the carrier or DMS operator has minimal maintenance or set up to perform on the data.

As described in the foregoing, the flight segment table 93 is derived from the seasonal 91 and/or operational tables 92 provided to the DMS 70 by the carriers. The flight segment table 93 is created for each possible flight segment provided by the carriers using the DMS 70 system. Thus, only a small number of tables, i.e. the flight segment table, the MCRO and some miscellaneous tables need be opened and interrogated in order to search for suitable routes in response to a search query. Relevant data from the different carriers has been de-normalized into at least an operational seasonal schedule 92, and then used to populate the relevant fields of the flight segment table 93. Thus, the many different systems and data utilized by different carriers are transparent to the user of the DMS 70 system, who merely sees the flight segment table 93.

In addition to the flight segment table 93 containing relevant information for any searches, there is MCRO table 98, and the transfer points table 100. A search query will still interrogate the MCRO 98 table to determine whether a requested route option is marketed by a carrier or carriers, that route in turn being limited by the transfer points defined in the transfer set table 100. However, once the marketed route has been established as an existing route for a carrier, and the transfer stations have been identified then the flights segment table 93 is utilized to find the flight segment or combination of flight segments which will fulfill a route query.

The other principal tables that are set up and accessed are the: member org table which details each carrier organization parameters; carrier service rating table which is specified by the forwarder for each carrier on the route; buyer seller involvement table which sets out whether the carrier does business with the forwarder in a quote and/or reverse markets manner; preferred carrier table which is a list of preferred carriers specified by the forwarder; aircraft/ULD compatibility table 84 for ULD searches and which set out which ULDs can fit on a given aircraft; ULD table 88 which is a list of DMS system implemented and operator ULD types; and various system parameters.

In an optional embodiment of the DMS 70, the transfer set table 100 may define transfers between carriers, for example carriers which are part of an interline arrangement. Alternatively, carriers may arrange unilateral agreements with each other and provide for transfer between respective flights.

The foregoing described data architecture is particularly advantageous in terms of flexibility and updating of data. If a carrier makes a change to a flight, all they need to do is to update the appropriate entry in their operational table 92. The DMS 70 determines by means of a poll, trigger or other such message that a change in a field has occurred, opens and interrogates the relevant carrier operational schedule table 92, and makes a corresponding update to the field in the flight leg table 92b and flight segment table 93.

Other changes may be made to an operational flight either directly through a user interface unit, via an unrolled change to a seasonal flight or via a batch update to the operational flight tables. The flight leg and flight segment tables are then automatically updated.

The data entity relationships illustrated in FIG. 6 show how a seasonal schedule 91 may be utilized to produce an operational schedule 92. The operational schedule is in great part the seasonal schedule entries having exact date and time applied to them, together with actual cargo capacity availability indicated. It is from the operational schedule 92 that the flight segment table 93 is generated. An example of the generation of the flight segment table 93 from the operational schedule 92 can now be described with reference to the flow diagram illustrated in FIG. 10.

At step 140 a flight instance identity is set, to determine which of the flight segments are to be generated. At step 142, the flight segments are constructed from the flight leg instance table 92b associated with the flight instance table 92a. Each possible combination of flight legs are evaluated, each one becoming a flight segment and populating flight segment table 93, associated with the appropriate flight instance identity, at step 144. The process of creating flight segments for each flight instance continues, until all possible flight leg segments have been created, providing a full flight segment table 93.

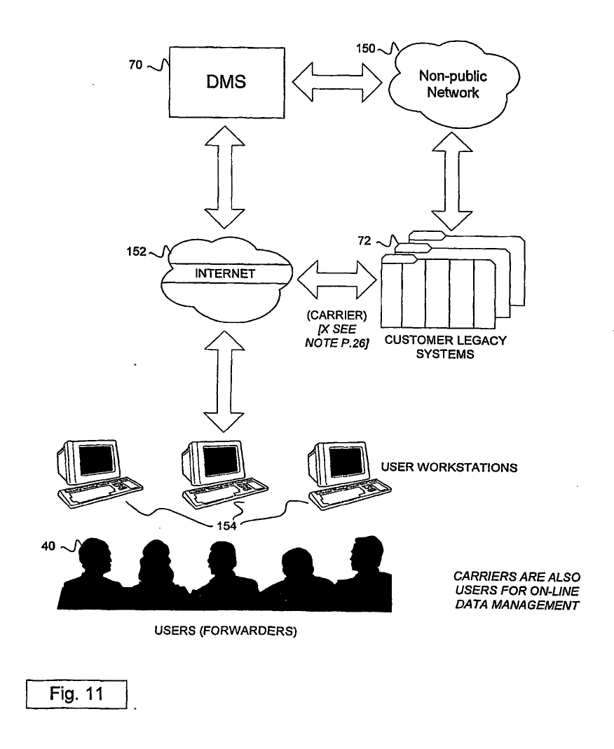

In a preferred embodiment the DMS is configured to be operable with both open and non-public computer networks. A particularly suitable configuration is illustrated in FIG. 11.

The DMS system 70, is coupled to customer's legacy systems 72 by a non-public network 150. Suitable non-public network links may be direct leased lines from telecommunications companies or links to non-public networks to which the carriers are connected, for example. The DMS system 70 is also coupled to a public network, such as the Internet 152. The legacy systems 72 may also be coupled to the Internet 152. Thus, clients may transmit data to the DMS system 70 via the non-public network 150 or the Internet 152. Such a configuration facilitates the scalability of the system, in particular the addition of new customers, since they need not provide non-public network links to the DMS system, but may choose to communicate via the Internet 152. Users of the DMS system, forwarders 40, access the DMS system 70 over the Internet 152 by means of workstations 154. The DMS system 70 can couple to forwarder system and carrier systems via public or non-public links.

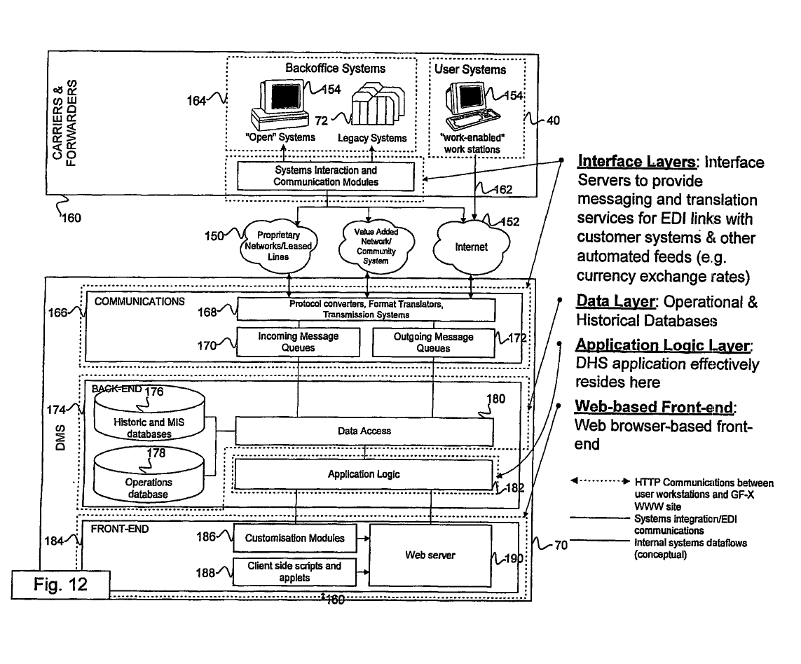

In the configuration illustrated in FIG. 12, the DMS system 70 is implemented as a Web Information System (WIS) at a website. Thus, it is accessible throughout the world by means of the global Internet. That is to say, any location that has access to the Internet may also have access to the DMS system, provided suitable access rights are granted to them by the operators of the DMS system. By configuring the system as a WIS, it becomes accessible by standard web applications. For example, all that a forwarder need have in order to interface with the DMS system is standard browser software and a connection to the Internet. Thus, the DMS system is platform independent and forwarders do not need any special hardware in order to access the DMS system. A particular advantage of configuring the DMS system 70 as a website is that it is relatively easy to scale up the service without forwarders 40 or carriers needing to upgrade or scale up their existing hardware or software (by for example having to install new versions of software). Other features provided by the DMS system are high resilience and high availability. Furthermore, the system is configured to preserve the confidentiality of sensitive information, control access to sensitive transactions, and to provide the service when and where it is needed.

A more detailed description of the DMS system and the carrier and forwarder systems will now be described with reference to FIG. 12. FIG. 12 describes the logical architecture of the overall system. The carriers and forwarders are shown as users of the system and are commonly labeled 160. The forwarders 40 use workstations 154 which are suitably “web-enabled”, for example running suitable browser software, and are coupled to the Internet 152. The communications link between the forwarder workstation 154 and the Internet 152 is either a dial-up or a permanently connected leased line. In a preferred embodiment of the invention, the protocol used for communication with the DMS is HTTP and HTTPS 162. The carriers have back office systems 164, comprising their legacy computer systems 72 and their open communication systems such as workstations 154 which are web-enabled and capable of coupling to Internet based applications. The back office systems 164 are coupled to systems integration and communication modules 166, which provide interfaces to outside networks and systems.

The DMS system 70 also comprises a systems integration and communications module 166 comprise interface servers which provide messaging and translation services for links with the customer 160 systems as well as other automated feeds, for example currency exchange rate information which may be obtainable from suitable information sites. The communications module 166 includes an interface module 168 comprising protocol converters, format translators and transmission systems. Interface module 168 provides suitable messaging and transmission services for the information within the DMS system 70 to be output over the proprietary networks 150 and over networks 152. The DMS interface module 168 also provides interfacing to web-based services such as currency exchange rate information, as well as other suitable information that may be utilizable by the system. Communications module 168 is internally coupled to incoming message queues 170 and outgoing message queues 172 to and from the back end 174 of the DMS system 70. The message queue modules manage the transfer of messages to and from the DMS back end 174. Back end 174 comprises two main databases, a Management Information database 176 and an operational database 178. The Management Information database stores historical and statistical information regarding transactions conducted on the DMS system. The operational database 178 comprises the relational database 74 containing the raw data from the carriers and the refined database 76 comprising the flight instance table. Respective databases 176 and 178 are accessed by data access control module 180. Data access control module 180 handles incoming messages on the carriers which require access to the databases, as well as handling outgoing messages to the carriers or forwarders comprising data from the databases.

The DMS system application logic 182 controls the data access control module 180, as well as the front end module 184 of the DMS system. The DMS application logic 182 comprises the functional modules for performing pre-calculation routines, 104, on the data received from the carriers in order to set up the flight instance table 76. Furthermore, the DMS application 182 also comprises the modules for receiving the raw data from the carriers and setting it up in the relational database 74 in accordance with tables as illustrated in FIG. 5. The search engine 106 also resides in the DMS application 182.

The front end 184 of the DMS system 70 comprises the customer or user interface aspects of the system. Typically, the front end comprises customization modules 186 and client side scripts and applets modules 188. The customization modules 186 are driven by the DMS application 182 and are set up to configure user interfaces, access rights and privileges as well as the format of any results in accordance with a particular user. For example, certain users may only be able to see flights offered by particular carriers or only certain types of cargo capacity. The customization modules 186 and client side scripts and applets modules 188 are coupled to a web server 190. The DMS application 182 is also coupled to web server 190. Web server 190 performs the usual tasks and functions of a web server and provides web access to the DMS system 70 to a user, e.g. forwarder 40.

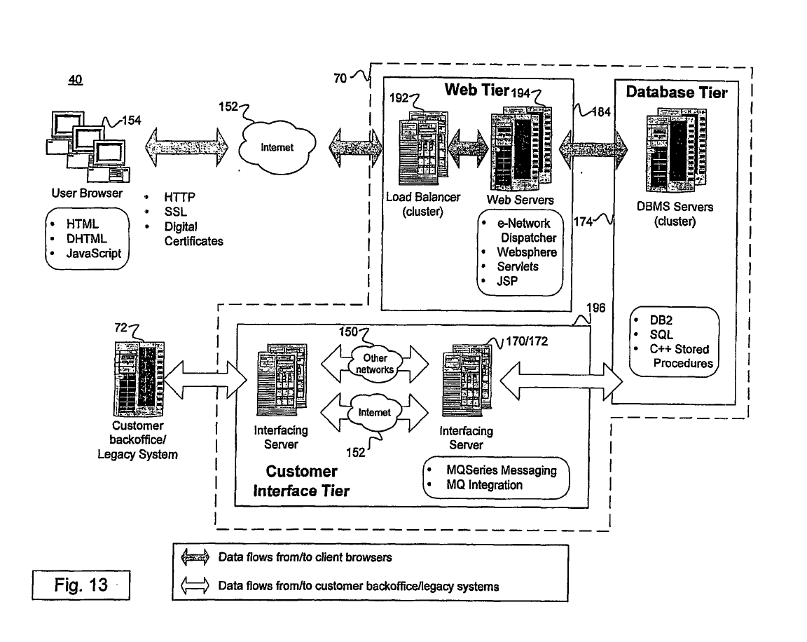

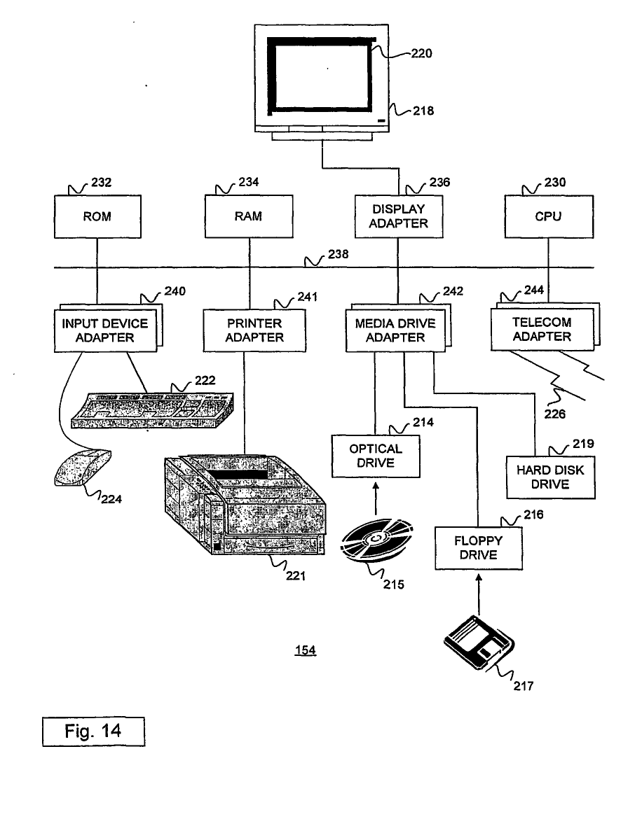

The physical architecture of the systems will now be described with reference to FIG. 13. Forwarders 40 make use of the system by virtue of workstations 154 running suitable browser software, typically interpreting HTML, DHTML and JavaScript code, for example. The workstations 154 are coupled over a telecommunications network supporting TCP/IP communications. Forwarders and the DMS may also exchange digital certificate information over the telecommunications system through the Internet 152 to mutually authenticate each other

The DMS system 70 front end 184 comprises a web tier. The web tier includes a load balancer. 192 for balancing the incoming and outgoing messages to and from the Internet. Load balancer 192 is coupled to a web/application server or servers 194 comprising suitable software modules for interfacing with Internet users such as application servers executing JSP and JAVA modules. The web/application servers 194 in the front end 184 are coupled to the back end 174 comprising the database tier. The database tier 174 includes a number of database servers. Suitably, the database servers operate a program language such as SQL and C++ stored procedures for controlling and operating the database. The back end or database tier 174 is coupled to a customer communications module or customer interlace tier 196. The customer interface tier 196 comprises the communications modules 168 and messaging queues 170 and 172 described with reference to FIG. 13. An interface server couples the backend 174 to other networks such as non-public and proprietary networks and/or the Internet. Suitably, the server handling the incoming and outgoing message queues 170/172 utilizes mechanisms such as MQ series, FTP and SMTP for handling the incoming and outgoing message queues.

Referring now to FIG. 14, there is shown a schematic and simplified representation of an illustrative implementation of a workstation computer system 154. The workstation 154 comprises various data processing resources such as a processor (CPU) 230 coupled to a BUS structure 238. Also connected to the BUS structure 238 are further data processing resources such as Read-Only Memory 232 and Random Access Memory 234. A display adaptor 236 connects the display device 218 to the BUS structure 238. One or more user-input device adaptors 240 connect the user-input devices, including the keyboard 222 and mouse 224 to the BUS structure 238. An adaptor 241 for connection of the printer 221 may also be provided. One or more media drive adaptors 242 can be provided for connecting the media drive, for example the optical disk drive 214, the floppy disk drive 216 and hard disk drive 219 to the BUS structure 238. One or more telecommunications adaptors 244 can be provided, thereby providing processing resource interface means for connecting the workstation computer system to one or more networks or to other computer systems. The communications adaptors 244 could include a Local Area Network adaptor, a modem and/or ISDN terminal adaptor or serial or parallel port adaptor etc as required.

It will be appreciated from the following description of embodiments of the present invention that the work station 154 may take many forms. For example, the work station may be a non-PC type of computer which is Internet or network-compatible, for example a Network Computer or set top box for a TV capable of providing access to a computer network such as the Internet. Optionally, the work station 154 may be in the form of a wireless PDA or a multimedia terminal.

Work station 154 is configured to operate under the control of CPU 230 operating in accordance with a computer program stored in the workstation memory 232/234/219. The program implementable by the workstation 154 may be supplied on a telecommunications medium, for example over a telecommunications network and/or the Internet. For a work station 154 operating as a multi-media terminal over a radio telephone network, the telecommunications medium may be a radio frequency carrier wave carrying suitably encoded signals representing the computer program and data information. Optionally, the carrier wave may be an optical carrier wave for an optical fiber link or any other suitable carrier medium or a land line link telecommunications system. Suitably, message and data structures and formats from the workstation 154 to a remote computer, such as the DMS system 70 or received from such a remote computer may also be supplied on any of the telecommunications media referred to above. Additionally, the program may be supplied on a floppy disk 217 or CD-ROM 215. In particular, a Graphical User Interface for a remote system, such as the DMS system 70, may be supplied over a telecommunications medium in order to configure the work station display device 218 to display a suitable Graphical User Interface on a display screen 220.

A forwarder 40 wishing to utilize the DMS system 70 in order to search for suitable flights for carrying cargo from an origin to a destination station must first log on to the DMS website. When logging on to the DMS website, a welcome page is displayed and if the forwarder has previously registered with DMS then all they need to do is provide suitable passwords and user names comprising their member id of the DMS system and member organization in order to authenticate themselves as a registered user to the system. In order to search for flights having a required cargo capacity, the forwarder 40 will request a capacity search.

Responsive to a search request 70 to the web server, a server-side java servlet in the Application Logic module 182 calls a decision making perform search stored procedure, dmPerformSearch, from the data access 180 in response to receiving the completed search parameters page. The dmPerformSearch module returns a list of results to the servlet which packages them in HTML and passes them on to the web server for transmission to the forwarder 40.

The search parameter page transmitted from the web server 190 to the forwarder's 40 workstation 154 is displayed by a browser on the display screen 220.

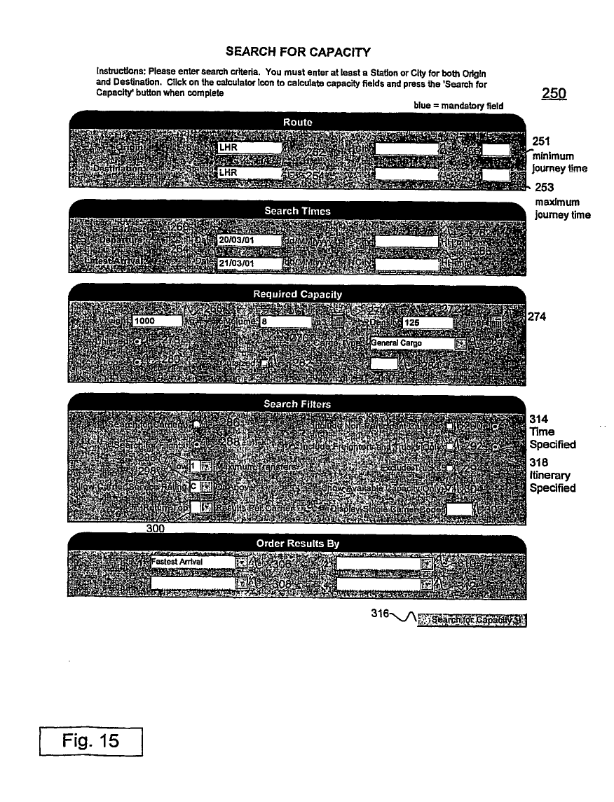

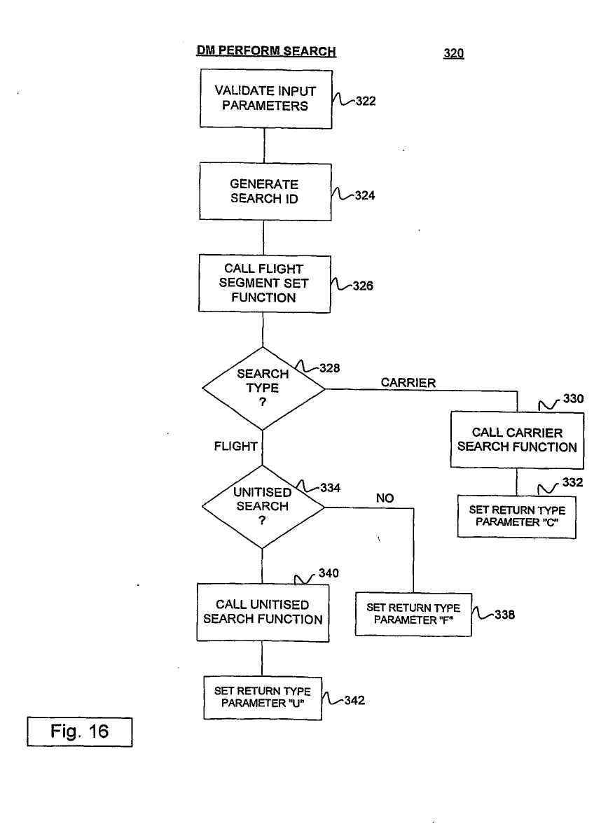

An example of a search user interface screen 250 is illustrated in FIG. 15. The forwarder 40 inputs the journey origin 252 and destination 254 airports into the appropriate screen fields 252 and 254. In the example illustrated in FIG. 15, the origin airport is London Heathrow and the destination airport is John F Kennedy airport in New York, having respective IATA designations LHR and JFK. Additional fields for origin and destination city, respectively 256 and 258 are also provided on the user interface 250 and can be completed as an alternative to inputting the original and destination into fields 252 and 254. Departure and arrival fields are also provided which are split into departure date 260 and time 262 and arrival date 264 and time 266, defining the window during which the forwarder 40 wishes to have the cargo transported from the origin to the destination. In a preferred embodiment, dates must be completed but times need not be. Fields 268 and 270 and 282 relate to the weight, volume and density of the goods for which cargo capacity is being searched. The calculator symbols 274 may be pressed to calculate the required volume if the weight and density are known or the density if the weight and volume are known. All three fields, weight, volume and density, need to be completed either by the user or automatically upon pressing the calculator icon in order for the nature of the cargo to be properly determined and the correct rate and value ascribed to it. Field 276 typically comprises a drop-down menu of different cargo types for which a search may be initiated. In the illustrated example, general cargo type is illustrated. Other types of cargo might comprise perishables, or auto parts, for example. Cargo type may be defined in any suitable manner by the DMS system operator.

The cargo type may be further defined in terms of whether it is loose cargo, i.e. boxes or packages, or unitized cargo, that is to say pre-packed into predefined cargo units. A simple toggle button unitized 278 or loose 280 may be activated to indicate the cargo type. In some circumstances, the cargo may be so-called outsized as defined by the IATA Rules, in which case field 282 is checked to indicate an outsized cargo. In field 284, the unitized packaging type may be entered for a unitized search, i.e. toggle button 278 is activated.

In a preferred embodiment, if loose cargo type is selected, a forwarder may enter dimension data relating to individual pieces of cargo within the shipment. Data fields for the dimension data are provided in a search interface screen (not shown) corresponding to search interface screen 250. The dimension data include the number, length, width, height and weight of each piece of cargo. A calculator icon such as calculator symbol 274 is provided to generate the volume and density from the dimensions data, if provided.

If unitized is selected, the forwarder is able to enter weight, volume, density and ULD category. The search screen (not shown) includes the ability to enter up to 3 ULD categories for a unitized shipment. The system will only return ULDs which have been mapped by the carriers to the categories specified in the search. Carriers map supported ULDs to the ULD categories. The forwarder need not define ULD categories if they would like to return all available ULD types. Carriers typically use one of the three international standard ULD typologies (TACT class rating, IATA type code or ATA US domestic terminology) and/or their own specific-specific ULD types. The DMS allows carriers to map their ULD types to more generic ULD categories which differentiate ULDs across broad dimensions, such as container/pallet, lower/main deck. The forwarder is able to define generic ULD categories in the search screen, to ensure that only those specific carrier ULD types are returned which correspond to the defined category. For example, a search for Pallet (lower) will return in the search results only those segment sets and ULD types which the carrier has mapped to Pallet (lower). The carrier will provide rates and aircraft ULD compatibility for their specific supported ULD types. Their supported ULD types will be returned in the search results and be the basis for quote market and reverse market bookings.

The lower half of the user interface screen 250 comprises a series of search filters which determine the results to be returned to the forwarder 40. Two toggle buttons 286 and 288 may be activated to either initiate a search which will return a list of carriers fulfilling the criteria, or a list of flights fulfilling the search criteria, respectively. Further options are to include non-participants in the system by checking field 290, to exclude passenger aircraft and mixed flights by checking field 292 and further to exclude trucks i.e. road transport, by checking field 294. Further search filters are the maximum number of transfers to be permitted which may be selected by means of a drop down menu 296, determining an allowed carrier service rating for the results to be returned which is selectable via drop down menu 298 and the ability to determine how many results one wishes to have returned by virtue of drop down menu 300. Further limitations may be to display only a single carrier code by checking field 302 and to show just the available capacity only, i.e. those results which can cater for the cargo capacity required by checking box 304. Optionally, carriers which have flights that are temporarily full may be requested, for purposes of future reference.

Finally, the forwarder 40 may determine the order in which the results are to be returned to them by prioritizing four different features. Four display fields are provided, each one having a drop down menu comprising the five following keys: preferred carrier, lowest cost, fastest arrival, latest departure, service rating. One or more fields 306-312 may be completed by using the drop down menus provided with each field, such that the results are ordered in accordance with the priority of the displayed keys.

A user submits their request to the DMS system by activating the “search for capacity” button 316.

User interface screen 250 may be configured to respond to a screen pointer controlled by the mouse 224 of the workstation 154 such that respective fields may be selected by user and data input into them by means of keyboard 222 or selection of options in a drop down menu. Optionally, the user interface program may move a prompt throughout the user interface 250 to each field in turn whereby a user may input such data as they may desire. Such a prompt may be controllable by means of the up/down arrow and tab keys typically found on a keyboard such as keyboard 222.

By means of the search user interface screen, a forwarder may explicitly select the type of search they wish to perform via the DMS system. There are four searches:—loose flight segments, loose carriers, unitized flight segments and unitized carriers. The terms “loose” and “unitized” refer to the nature of the cargo packing. A flight segments search will return a set of results including full details of the flights segments for the requested route, whereas a carrier search will provide just carrier identification and optionally available capacity. Certain fields have to be completed for each type of search. These fields are the route between origin and destination, which could be a city or airport, the search times, the cargo type and cargo capacity. There is a system defined maximum time period between departure and arrival times in order to ensure that excessively long periods are not entered. If this system parameter is exceeded, the system will issue an error. Airports are generally associated with a city by an IATA table.

For each flight segment entry 93 there is a departure date and time (DEP_DTIME) and arrival date and time (ARR_DTIME). Each flight segment entry also has an origin and destination station for the flight segment. In one embodiment an export handling time and import handling time are also included. The export handling time is the time required at the origin station for handling before the flight departs. Export handling time is subtracted from the departure time to define a drop-off time (in fact a latest drop-off time). Similarly, the import handling time is the time required at the destination station for handling after the flight arrives. Import handling is added to the arrival time to define a pick-up time (in fact an earliest pick-up time) for the shipment. A drop-off time and pick-up time is thus established for each flight segment in the flight segment table.

In accordance with a preferred embodiment of the invention, a search may be envisaged to be time specified or itinerary specified (flight specific).

For an itinerary specified search (i.e. a search by departure and arrival date and time), the DMS searches the flight segment table and related tables for route segments with departure and arrival dates and times satisfying the request (where departure date and time is later than or equal to start (requested departure) date and time and arrival date and time is earlier or equal to end (requested arrival) date and time). The results may be displayed with the departure and arrival dates and times and/or with the associated drop-off and pick-up dates and times.

For a time specified search (i.e. a search by drop-off and pick-up date and time), the DMS searches the flight segment table and related tables for route segments with drop-off and pick-up dates and times satisfying the request (where drop-off date and time is later than or equal to start (requested drop-off) date and time and pick-up date and time is earlier than or equal to the end (requested pick-up) date and time). Again, the results may be displayed with the departure and arrival dates and times and/or with the drop-off and pick-up dates and times.

FIG. 16 illustrates a flow diagram for an illustrative embodiment of the dmPerformSearch stored procedure. The dmPerformSearch stored procedure resides in the DMS data access logic 180 and initially validates the input parameters for a search request from a forwarder, step 322. Typically, the dmPerformSearch stored procedure validates the following input parameters which may be input by the search for capacity user interface screen 250 or as part of the log-on procedure and the search for capacity screen 250.

Typically, the following input parameters where applicable are validated:

a member ID parameter is passed in;

a result type search parameter is passed in;

a loose or unitized (278,280) search parameter is passed in;

results type (carrier or flights) 286,288;

ensure origin airport or origin city parameters (252,256) are passed in;

ensure the destination airport or destination city parameters (254,258) are passed in;

ensure that the origin city (256) if passed in is a valid city;

ensure that the origin airport 252 (if passed in) is a valid airport;

ensure that the destination city 258 (if passed in) is a valid city;

ensure that the destination airport 254 (if passed in) is a valid airport;

ensure that origin airport and origin city have not both been entered;

ensure that destination airport and destination city have not both been entered;

ensure that the origin is not the same as the destination for both airport and city;

ensure that origin station is not situated in the destination city;

ensure that destination station is not situation in origin city;

ensure that the maximum transfers parameter has been passed in;

ensure departure and arrival dates are passed in and that arrival date is after departure;

ensure that time between departure and arrival dates is not longer than a system defined maximum;

ensure that the cargo type 276 has been passed in and is a valid cargo type for the system;

ensure ULD category 284 (if entered) is valid;

ensure that the carrier code 302 (if entered) is valid;

ensure that weight, volume and density have been entered and that weight/volume=density; and

ensure that piece dimensions and weights, if entered, correspond to the weight and volume, within a system tolerance.

The dmPerformSearch function then proceeds to step 324 where it generates a unique search identity for the search requested. This search identity is used to identify a search result set formed when retrieving results sub-sets. A common function called Result Set ID utilizes the unique search ID and enters the unique ID into a record VU_SRCH_RSLT_SETU to record the time at which the search was performed. This record is then used in the DMS management system to determine when a search should be removed from the database. The unique search ID is returned to the client software once search processing is complete, for use in identifying the search result set.

The next step 326 calls a FlightSegmentSet function which is used to generate a list of flight segments that fulfill the search criteria entered in the search screen, e.g. 250, in terms of the journey origin and destination stations, the route, start and end dates and capacity availability. This list of flight segments is used for all search routines that are performed subsequently. The dmPerformSearch procedure then proceeds to step 328 in which it is determined whether the search is of the carrier type or the flight type as determined by toggle switches 286 and 288 respectively in the search for capacity screen 250, for example.

For a carrier type search, the dmPerformSearch stored procedure proceeds to step 330 where the carrier search function is called to perform the carrier search and the return “type” parameter “C” is set at step 332. For a flight type search, the function control flows to step 334 where it is determined whether a unitized type search has been requested. If a unitized search has not been requested then at step 336 a flight search function is called which will search for flights carrying loose cargo. Then the control flows to step 338 in which a return type parameter “F” is set. For a unitized search function control flows to step 340 where a unitized search function is called and thence to step 342 where a return type parameter “U” is set.

Once the dmPerformSearch stored procedure has been conducted and the relevant search type, i.e. carrier search 330, non-unitized search 338 or unitized search 340 has been undertaken, a search results set is established reflecting the results of the appropriate search. From the search results set, the pricing of individual records within that set is performed.

The procedure function “FlightSegmentSet” 326 is called in the dmPerformSearch procedure 320. The dmflightsegmentset 326 is executed for all search types and inserts into the result set table the list of flight segment sets that match the route specified in the search for capacity screen 250. Each flight segment set forms a row of data stored on the result set table, and the list is configured such that a requested number of rows can be returned to a JAVA servlet by a getresults function for communication to a user workstation 154. The dmflightsegmentset search is a complex search and the search is performed in several distinct queries from which the complete result set is constructed. Each query is performed in turn and the output from the search is inserted onto the result set table, along with relevant search ID. Each individual query corresponds to the number of transfers allowed in the route.

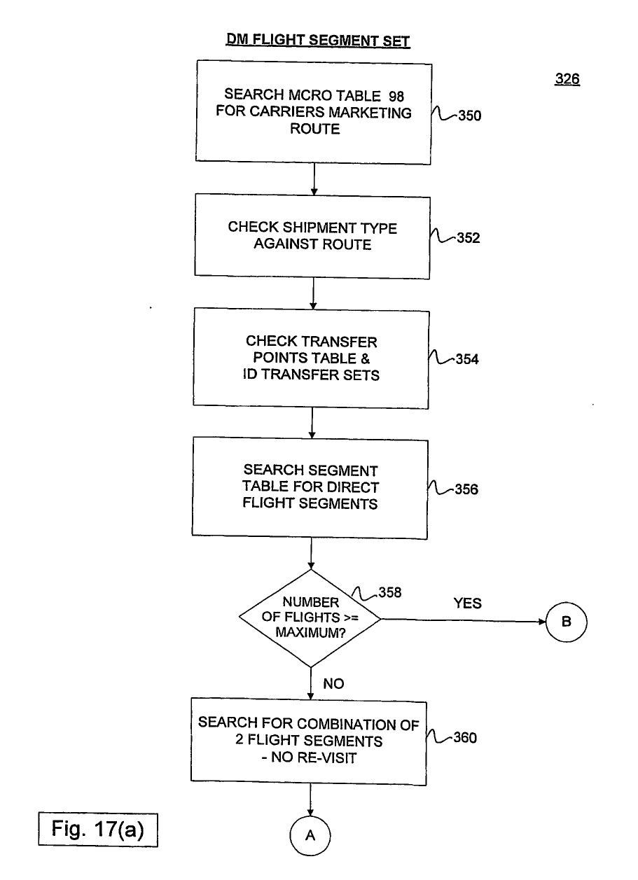

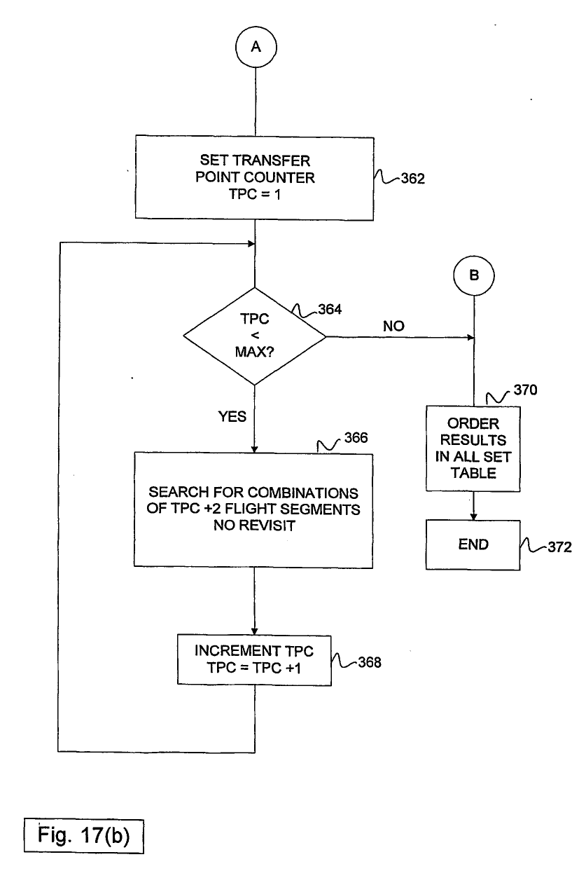

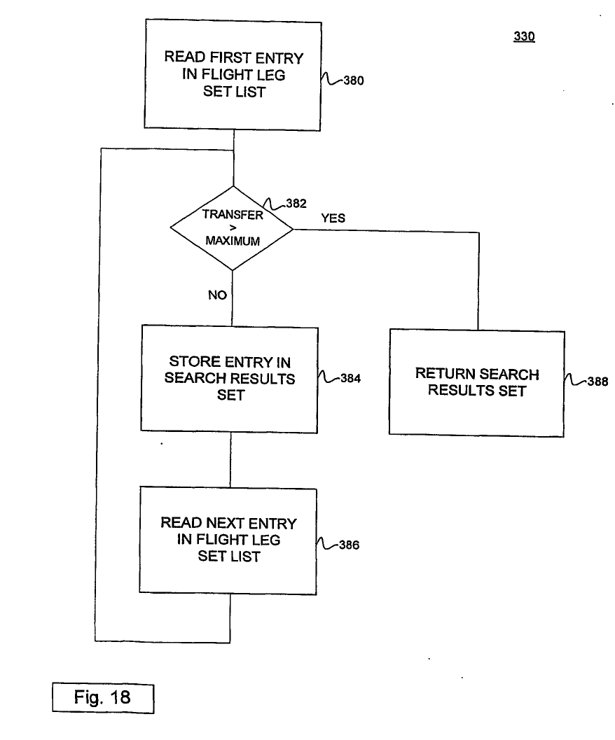

Operation of the DMS application logic 182 for the dmflightsegmentset 326 will now be described with reference to the flowchart illustrated in FIG. 17. The dmflightsegmentset stored procedure starts at step 350 by searching the MCRO table 98 for carriers which market the journey entered onto the search window 250. In the example illustrated in FIG. 16, the MCRO table 98 will be searched for an origin airport LHR and a destination airport JFK. At step 352 the requested shipment type, i.e. unitized or loose, is also checked against the route marketed by the relevant carriers. A list of the carriers marketing the requested route, with the requested shipment types is then stored by the dmflightsegmentset procedure. Other checks that may be carried out in steps 350 and 352 are that the carriers have an adequate service rating, parameter 298 in screen 250. At step 354 the transfer point table 100 is checked to identify the transfer sets valid for the marketed route for each carrier.

Flight segment table 93 is then searched at step 356 for direct flight segments having origin and destination stations corresponding to the origin and destination stations for the requested journey. Each of the direct flight segments is checked against the conditions entered into the search for the date period defined by search parameters 260,262,264 and 266 of screen 250 and includes the latest booking acceptance time conveyed by route and flight. Additionally, if the result is to be filtered by capacity then a search for the necessary capacity is also undertaken as well as a search for the appropriate equipment type as defined by search parameters 292 and whether or not to include trucks as defined by search parameter 294. The DMS application logic also checks that each of the flight segments has its departure and arrival times within a maximum time period as set by a system parameter.

The direct flight segments identified in step 356 satisfying the query are stored in a flight segment set list. The dmflightsegmentset stored procedure then proceeds to step 358 where it is determined whether a maximum number of flights have been identified. The maximum number of flights is typically a system parameter but optionally may be user defined. If a maximum number of flights has been identified then the dmflightlegset stored procedure process control flows to step 370 where the results in the flight legset list are ordered and the dmflightlegset procedure ends at step 372. However, if the result of step 358 is no then the process control flows to step 360 at which the flight segment table is searched for a combination of two flight segments fulfilling the journey request. In a preferred embodiment of the invention, the two flight segments are for flights with the same managing carrier, but optionally they may be for flights having different carriers.

When searching for a combination of two flight segments, the connection of the two flight segments is handled by comparing the connection time i.e. difference between the arrival and departure of the two flight segments at the transfer station against the carrier minimum connection time as defined in the minimum connection time table 96. Two flight segments can only be connected if the time difference between their connection time and carrier minimum connection time is acceptable. That is to say, there has to be sufficient time in which to make the connection and transfer. The carrier minimum connection time varies depending upon aircraft, shipment type (loose or unitized) transit station etc as discussed with reference to FIG. 8 when discussing table 96. Additionally, the connection time is compared with the maximum connect time system parameter, to determine whether or not the time difference is acceptable. Optionally, the connection time is also compared with the appropriate field in the maximum connect time table 94. Again, the maximum connection time may vary depending upon aircraft type, shipment type (loose or unitized), and the transit station as well as other variables such as the nature of the cargo, as discussed with reference to FIG. 7. Additionally, each of the combined flight segments, collectively known as a trans-shipment, is checked against a maximum journey time for the marketed route stored in the MCRO table 98 and any which exceed the maximum journey time are discarded. A further condition for trans-shipment tested at step 360 are that the next flight's origin matches the previous flight destination. The flight segment set list is then updated with the trans-shipments identified in step 360.

Process control then flows to step 362 where a transfer point counter TPC is set to 1. This counter is used in order to check that the number of transfer points in a route do not exceed a user's specifications or a system parameter. At step 364, it is checked whether or not the transfer point counter TPC is less than a maximum value. If it is not less than a maximum value, then process control flows to step 370 where the flight segment list results are ordered, and thence to step 372 where the procedure ends. If the result at step 364 is yes then process control flows to step 366 where the segment table is searched for further combinations of flight segments. The number of flight segments which are searched is equal to TPC+2. The considerations when undertaking the search in the segment table in step 366 are the same as that undertaken in relation to step 360. However, there is a further restriction in that no transfer point can be re-visited during the trans-shipment. That is to say, a flight segment destination does not match a previous flight segment origin. This is to avoid convoluted and repetitive trans-shipment routes. Valid trans-shipments derived in step 366 are stored in flight segment list and process control flows to step 366 where counter TPC is incremented by 1. Then control flows back to step 364 where it is determined whether or not TPC is less than a maximum value.

Importantly, when searching the flight segment table for a combination of two or more flight segments, a check is made that each flight segment is capable of transporting cargo as set out in the request in terms of cargo compatibility for cargo type, dimensions and/or ULD type, for example. For instance each segment must be capable of transporting cargo having the dimensions set out in the request or of the ULD type requested.

The result of the dmflightsegmentsetprocedure is to produce an ordered flight segment set list. The ordering is in accordance with the order results parameters 306,308,310,312 and 314 input on the search screen 250. Having completed the dmflightsegmentset stored procedure function 326, process control flows to the dmPerformSearch stored procedure 320 where the search type is determined at step 328.

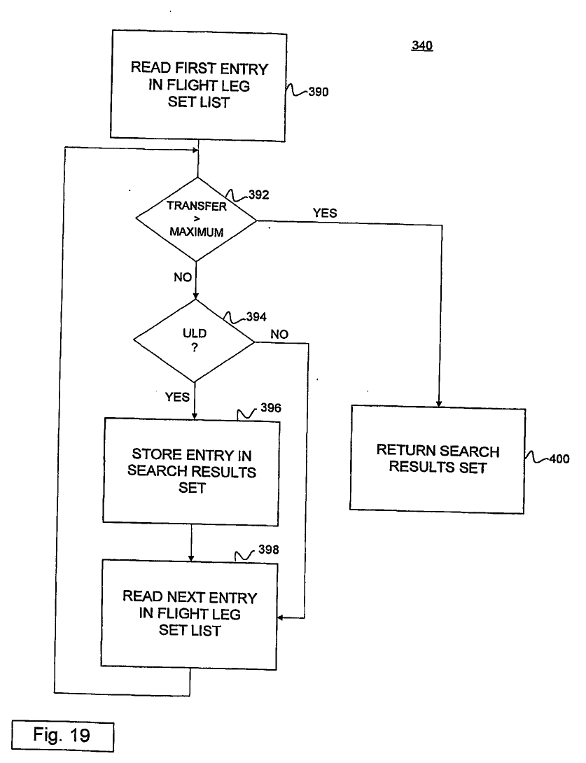

Returning now to FIG. 16, at step 328, search type to be performed by the perform search algorithm 320 is determined. For a search type “carrier” initiated by setting the toggle button 286 in search window 250, a carrier search function 330 is initiated. The process control flow for the carrier search function 330 will now be described with reference to the flowchart illustrated in FIG. 19. Initially, at step 380, the first entry in the flight segment set list is read. At step 382, it is determined whether the entry exceeds a maximum value as entered by the user in parameter 296 at search window 250. If the number of transfers is less than the maximum entered by the user, process control flows to step 384 where the entry is stored in a search results set. Next, step 386, the next entry in the flight segment set list is read and process control flow returns to step 302 to determine whether the number of transfers in the next entry exceeds the maximum allowed. If the number of transfers does not exceed the maximum, then the process control continues and flows to step 384 where the entry is stored and the search results and the next entry is read from the flight leg set list. However, if the number of transfers in the most recently read entry of the flight leg set list exceeds the maximum value, then process flow control moves to step 388 where the carrier search function is terminated and the final search result set is returned to the perform search procedure. For the carrier search, the final search result set comprises a list of carriers with flights and cargo capacity sufficient to fulfill the request.

Referring now to FIG. 19, the control flow for the unitized search function 340 will now be described. For a unitized type search activated by setting the toggle button to 278 in the search window 250 an additional check in the DMS logic for whether each flight segment uses an aircraft type capable of handling ULDs generally or a specific ULD type. ULD categories may be entered in field 284 of the search window 250. For the example illustrated in FIG. 15, no entry has been made in field 284, which is consistent with the search being for loose capacity responsive to the loose toggle button 280 being activated. The first step 390 of the unitized search function 340 is to read the first entry in the flight segment set list. At step 392 it is determined whether or not the number of transfers for the entry exceeds a maximum. If not, the process control flows to step 394 where it is determined whether or not the entry contains a flight segment capable of supporting ULD unitized cargo generally, or if a ULD category has been entered that the flight segment supports that specific ULD type. If the result of step 394 is yes then process control flows to step 396 where the entry is stored in the search results set. Then, at step 398, the next entry in the flight segment set list is read and process control flows to step 392 where it is determined whether or not the number of transfers for that next entry exceeds the maximum value. At step 394, if the current read entry does not support the ULD cargo, or a specified ULD type, then process control flows to step 398 where the next entry in the flight segment set list is read. If the result at step 392 is yes, that is to say the number of transfers in the currently read entry from the flight segment set list exceeds a maximum value, then process control flows to step 400 where the search results set is returned to the dmPerformSearch stored procedure 320. Search results sets are only returned where each flight segment supports a common ULD type or types.

A search results set has now been created corresponding to the respective search type requested by the forwarder. Preferably, a price is associated with each flight segment set record. In the simplest case the price may be a function of the volume, weight or density of the cargo capacity request. Such a price per unit of capacity may be included at an entry in the MCRO 98 table. Optionally, the price may be an entry for each flight leg in the flight instance table 76 with the price for each flight leg in a combination of flights forming a segment and/or route being summed to give a total price for that route.

Optionally, rate cards are provided on the DMS system which are configured by many different parameters, including route and flight segments or flight legs, to calculate a rate for a journey.

The rate cards are created and maintained by carrier by route, journey, forwarder, cargo type, day of week, for example. The DMS system finds the correct rate card for each flight segment set and calculates a rate taking into consideration shipment type, weight amongst other things. The rating or revenue management information held against the MCRO referred to above, includes a minimum for that route, below which the calculated rate is not allowed to fall. It is a minimum rating control. The system compares the rate on the rate card with the rate on the MCRO and takes the minimum of the two.

Other means for determining the price for the cargo capacity may also be utilized.

The search results, as created by the appropriate search, i.e. carrier, non-unitized or unitized search, are then displayed in the order selected by the user in the relevant search screens. The user then selects for which of the selected route options they wish to book cargo capacity. In a preferred embodiment of the invention, cargo capacity booking is done by selecting one of the flight segment sets in the results list, which initiates the generation of a booking screen which may be filled out by the user in order to book cargo capacity. Optionally, booking of cargo capacity may be by more conventional means such as a fax, telephone, or e-mail to the relevant carrier.

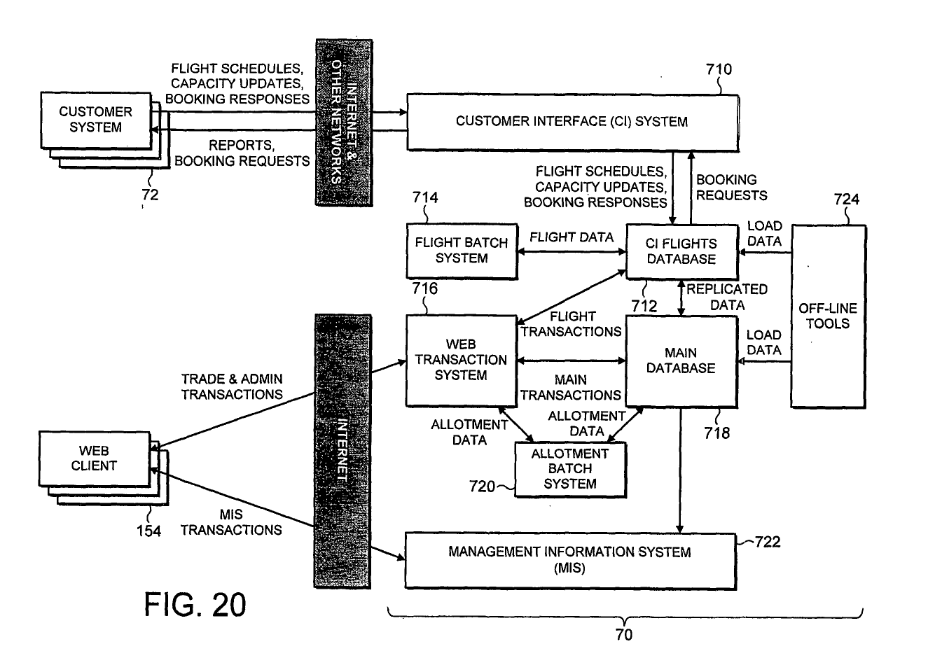

The logical architecture of a particularly suitable data management system (DMS 70) in accordance with an embodiment of the present invention will now be described with reference to FIG. 20. FIG. 20 shows the overall system. Customer (carrier) systems 72 communicate with customer interface (CI) system 710 across the Internet and/or other networks, as already described with reference to FIG. 12. CI system 710 interacts with CI Flights Database 712 which in turn interacts with Flight Batch System 714, Web Transaction System 716 and Main Database 718. Web Transaction System 716 and Main Database 718 also interact with one another.

Allotment Batch System 720 interacts with Web Transaction System 716 and Main Database 718. Main Database 718 interacts with Management Information System (MIS) 722. Off-line tools 724 can be used to load carrier and forwarder data gathered off-line into the CI Flights Database 712 and Main Database 718. Web Transaction System 716 and MIS 722 communicate with client (forwarder and/or carrier) work stations 154 across the Internet and/or other networks.

The Web Transaction System 716 comprises a web application server and database access software and enables forwarders using workstations 154 to submit search requests to the data management system. The MIS 722 uses data from the main database 718 to generate on-line reports, and the Allotment Batch System 720 is used to load allotment bookings and templates received via the Web Transaction System 716 into the main database 718.

Carrier systems 72 supply flight schedules to the CI system 710 either as seasonal schedules 91 with standing flight timetables or operational schedules with individual flight instances. The CI system 710 stores the flight schedules in operational schedule tables 92 and seasonal schedule tables 91 in the CI Flights Database 712. Capacity data for populating the flight segment table is also provided.

Marketed Carrier Routes Options (MCRO) data and Transfer Set data are also supplied by the carrier system 72 to the CI system 710, and these are stored in the Main Database 718 in MCRO table 98 and transfer set table 100 respectively. Copies of the MCRO table and transfer sets table are held in the CI Flights Database. ULD data is similarly received and stored in ULD tables 82. Operational schedule table 92, seasonal schedule table 91, MCRO table 98, transfer set table 100 and ULD table 82 and their relationships have been described with reference to FIGS. 6 and 9.

Flight Batch System 714 runs a batch process to unroll a carrier's seasonal schedule 91 to produce an operational schedule 92. As described with reference to FIG. 5, the operational schedule sets out the origin and destination stations, the time and date of departure, equipment type and the ability to on-load and off-load cargo at each station for each flight. When pre-calculation routine 104 creates flight segments for the flight segment table, valid combinations are made for segments which have an on-load capability at the origin station and an off-load capability at the destination station. In a preferred embodiment, flight legs are only combined by pre-calculation routine 104 to form segments in the flight segment table if the flight legs belong to the same flight i.e. have the same flight number.

In other embodiments different rules may be followed for combining flight legs to produce flight segments in the flight segment table. For instance a carrier may specify via an identifier which legs may be combined with which to form segments

In a preferred embodiment MCRO table 98 and transfer set table 100 are used to define a marketed carrier route segments set by for example creating a marketed carrier route segments table containing all of the permissible route segments defined by the data in these tables. For example, if a carrier is marketing LHR-SIN directly and LHR-SIN via DXB, assuming load-on and load-off capability at DXB, then the marketed flight segments LHR-DXB, DXB-SIN and LHR-SIN will be created. However, if only LHR-SIN directly is being marketed then only the marketed flight segment LHR-SIN will be created. Pre-calculation routine 104 when populating the flight segment table reads data representing a flight leg or valid flight leg combination from the operational schedule and checks the origin and destination stations against those of each marketed flight segment. If the flight leg or flight leg combination corresponds to a marketed flight segment then the leg or flight leg combination will be entered into the flight segment table as a flight segment. If the flight leg or flight leg combination does not correspond to a marketed route segment then it is not entered into the flight segment table. Therefore in the example above a leg DXB-SIN would be entered into the flight segment table as a segment only if a corresponding marketed flight segment exists i.e. in the first part of the example but not the second part of the example.

The MCRO table 98 and transfer set table 100 are preferably still used in the dmPerformSearch procedure to first act as a check that the data in these table has not changed (been updated) and secondly check that if the search concatenates two or more segments that the concatenated search result corresponds to a marketed route and/or valid transfer.

Referring again to FIG. 20, the Flight Segment table formed in the CI Flights Database 712 is replicated to the Main Database 718 to support main transactions (customer searches) performed through the Web Transaction System 716. Main Database 718 holds the MCRO table, transfer sets table, ULD table and other tables used for customer transactions including the member org table, rating table, buyer seller involvement table, preferred carrier table and aircraft/ULD compatibility.

In an embodiment corresponding to the system shown in FIG. 20, the CI System 710 and CI Flights Database 712 are implemented as a CI server on a separate server to the main database 718, Web Transaction System 716 and Allotment Batch System 720. The CI System as well as receiving and handling Flight Schedules and populating the flight segment table, handles the exchange of other data between the carrier legacy systems (Customer/carrier systems) and the main database 718. This includes handling capacity updates, MCRO updates, transfer set updates, updates of other carrier data and the handling of booking requests generated through the DMS system and booking responses from the carrier system. Updates are cascaded to related tables using database triggers. In addition, the CI server ensures that this data is kept accurate and current.

The key data elements include flight schedule information, air cargo capacity, rates and bookings, allotment bookings and templates. This data is transferred from Carrier Systems, stored and used by the DMS 70 to provide a Network (Internet)-based market place for trading air cargo capacity. The accuracy and currency of the carrier data stored in DMS 70 is critical to the viability of the market place.

The mechanisms typically used in the industry for transferring data between legacy systems (EDI) are poor. The carrier legacy systems themselves are diverse and dated. There are significant technical challenges in assembling data in a predictable and timely way for the purposes of establishing an exchange.

To solve these challenges, the DMS 70 provides a robust, extensible customer interface architecture, which provides for a wide range of data formats and delivery mechanisms to cope with the different carrier approaches. It is possible to tailor these formats and mechanisms by carrier according to the limitations of each carrier's specific legacy system. In particular, DMS 70 provides a configurable capacity polling functionality, which enables DMS 70 to ensure that all carriers' capacity information displayed on the exchange is up to date, allowing forwarder users to book accurately via DMS 70.

As described with reference to FIG. 20, the DMS 70 comprises a customer interface server and database (CI Server) and a main application server and database. In one embodiment, the CI Server resides outside the DMS 70 as a separate component but in other embodiments both CI server and main application server may be one and the same. The air cargo transactions are carried out on the DMS 70 System, using carrier and forwarder data managed and stored on the DMS 70 System. The data exchanges are carried out between the carrier legacy systems (Carrier System) and the CI Server.

To cope with the wide variation in carrier legacy systems, the CI Server supports several data formats and delivery mechanisms for each of the data feeds. Carriers will select the most appropriate data format and delivery mechanism, according to their system capabilities and preferences.

The data feeds that are exchanged between the CI Server and the Carrier System are as follows: booking details and confirmations, capacity requests and updates and seasonal and operational flight schedules. These are the critical data elements assembled by DMS 70 for the purposes of providing the exchange.

The data formats supported by DMS 70 are as follows: Extensible Markup Language standards defined for DMS 70 (XML), IATA Cargo Interchange Messaging Procedures(Cargo-IMP), IATA standard schedule information manual, and DMS 70 specified flat file structures, for allotment templates allotment bookings and the operational schedule, for example. The Cargo-IMP standard is relatively widely used in the industry, but is inflexible and limited in terms of the data that is transferred. For example, it only provides no pricing information in the bookings message and the remarks fields are small. Moreover, it is a relatively dated mechanism for transferring data and suffers from historic technical constraints. The XML and flat file formats are developed for DMS 70 and include more data elements and provide for additional flexibility in the data transferred.

The delivery mechanisms supported by DMS 70 are as follows: MQSeries (an IBM proprietary messaging protocol) and Simple Mail Transfer Protocol (allowing carriers to transfer messages using TCP/IP e-mail), File Transfer Protocol (FTP), Type B and HTTP.

The architecture of the interface is configured to allow carriers to choose a data format and a delivery mechanism (albeit with some restrictions on certain combinations) for each of the data feeds, depending on the limitations set by the Carrier System. This provides for an extremely tailored solution for each carrier. In addition carriers may change their configuration through time as they develop their own interfaces with their legacy systems, making the solution flexible and extensible.

Special provision has been made for obtaining the available capacity on the flights that carriers market in DMS 70. There are three alternatives permitted to carriers: (1) the DMS 70 CI Server polls for capacity updates at frequent intervals during the day, where frequencies are set by each carrier and vary according to time to departure; (2) carriers send unsolicited capacity update messages to DMS 70 when the capacity changes on a flight leg; and (3) carriers deliver a capacity update data file at frequent intervals which contains all the changes made to capacity in the intervening period. These alternatives, plus data format and delivery mechanism options outlined above, allow carriers to ensure that capacity data held in DMS 70, which provides the basis of DMS 70 bookings, is as current as possible given Carrier System limitations.

There are a number of combinations of possible data formats and mechanisms which are set out below.

| | | Data Format/Delvery | | | | | | | | |
|---|---|---|---|---|---|---|---|---|---|---|
| | | XML | | | Cargo-IMP | | | Flat File | | |
| Data | Data | M | SM | FT | M | SM | FT | M | SM | FT |
| Feeds | Flow | Q | TP | P | Q | TP | P | Q | TP | P |
| Booking | GFX -> | Y¹ | Y | N² | Y | Y | N | X³ | X | X |
| Details | Carrier | | | | | | | | | |
| Capacity | GFX -> | Y | Y | N | Y | Y | N | X | X | X |
| Requests | Carrier | | | | | | | | | |
| Capacity | Carrier -> | Y | Y | N | Y | Y | N | Y | N | Y |
| Updates | GFX | | | | | | | | | |
| Seasonal | Carrier -> | N | N | N | X | X | X | Y | N | Y |
| schedules | GFX | | | | | | | | | |
| Opera- | Carrier -> | N | N | N | X | X | X | Y | N | Y |
| tional | GFX | | | | | | | | | |
| Schedules | | | | | | | | | | |

¹Y -Supported in Version 1
²N - Supported in later Version
³X - Not possible

As indicated above, the DMS 70 provides three alternatives for obtaining the available capacity on the flights that carriers market using the DMS:

The CI Server polls for Capacity Updates at frequent intervals during the day

Carriers send unsolicited CAPACITY UPDATE messages to DMS 70 or the DMS administrator

Carriers deliver a Capacity Updates Data File at frequent intervals (minimum once a day).

Polling for Cargo Capacity

The DMS application sends Capacity Requests for station pairs that make up a Flight Leg. The DMS application preferably does not send requests for capacity at the Flight Segment level, but may be configured to do so. The DMS application calculates available capacity for a flight segment as the minimum of any of the flight legs within a flight segment. If a ZERO capacity is returned for a flight leg, then ALL flight segments that contain that flight leg will be shown as having ZERO capacity within the DMS 70.

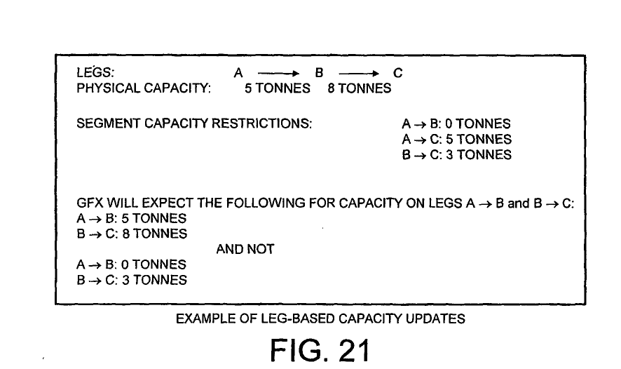

For example: AB 123 flies LHR→DXB→SIN. DMS 70 will send requests for Flight Legs LHR→DXB and DXB→SIN. DMS 70 will NOT request capacity for the flight segment LHR→SIN. If a ZERO capacity is received for leg DXB→SIN then the Flight segment LHR→SIN will be shown with ZERO capacity. FIG. 21 illustrates an example of leg-based capacity updates.

The implications for Carrier Systems are the following:

Responses must contain the true physical capacity available on the flight leg, irrespective of any capacity control tools, marketed routes or onload/offload restrictions at the segment level.

A zero capacity value must be returned when there is no capacity on a leg (as opposed to no response being sent).

Capacity Request

DMS 70 has four options for the capacity request message. The capacity request message corresponds to the Capacity Update Request message in XML format or the FVR message in Cargo-IMP format. Carriers will have to select one of four options.

1 Capacity request message for all the carrier's flights operating between a station pair for a date range (This option is not supported by the FVR (Cargo-IMP) message).

2 Capacity request message for all the carrier's flights operating between a station pair on a specific date.

3 Capacity request message for a specific flight operating between a station pair for a date range. This option is not supported by FVR (Cargo-IMP) message)

4 Capacity request message for a specific flight₁₃ operating between a station pair on a specific date.

Polling Algorithm

1. The DMS 70 preferably has three polling windows each of which has an associated polling frequency, although any number of polling windows may be used.

2. A polling window defines a range of days forward from the current point in time. The window sizes are preferably configurable at DMS system level i.e. they are the same for all carriers.

b 3. The polling frequency associated with each window is preferably configurable at a carrier level, but can be agreed between the DMS administrator and each carrier, within system-defined minimum/maximum values.

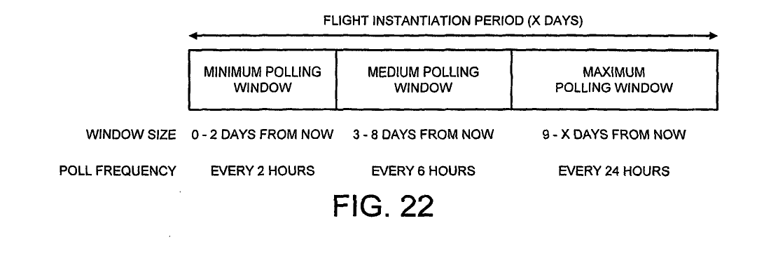

FIG. 22 illustrates an example of a polling window.

### EXAMPLE

Flight AB123 flies from LHR-DXB-SIN daily.

Assume that DMS 70 has configured carrier AB to use the option 2 of the Capacity Request message. DMS 70 will send the following poll requests (for window sizes and polling frequency example in diagram above):

2-hour intervals

LHR-DXB for today's departure

DXB-SIN for today's departure

LHR-DXB for tomorrow's departure

DXB-SIN for tomorrow's departure

LHR-DXB for tomorrow+1 departure

DXB-SIN for tomorrow+1 departure

6-hour intervals

LHR-DXB for tomorrow+2 departure

DXB-STN for tomorrow+2 departure

. . .

LHR-DXB for tomorrow+5 departure

DXB-SIN for tomorrow+5 departure

. . .

LHR-DXB for tomorrow+7 departure

DXB-SIN for tomorrow+7 departure

24-hour Intervals

The same pattern is followed.

In response to each poll request, DMS 70 would expect to receive a capacity response message with the capacity details of flight AB 123 together with any other AB flights operating the same station pairs (LHR-DXB, DXB-SIN).

Capacity Response

In response to poll requests the carrier system should send messages that satisfy the following criteria:

Flight legs matching the requested station pair/date (or date range) (and flight number if specified)

Include flight legs with zero capacity

All capacity requests need a capacity response message returned to DMS in order to acknowledge delivery of the poll request

Details of zero or more flight station pairs will be included in the Capacity Response message

Capacity Update Messages

The Capacity Update message corresponds to the CQA message in XML format or to the FVA message in Cargo-IMP format.

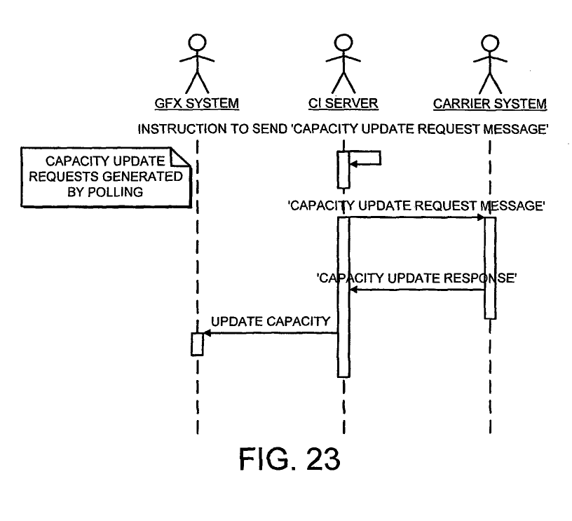

An illustration of a sequence diagram for capacity update messages is shown in FIG. 23. The polling for capacity updates is originated in the CI Server. The CI Server generates Capacity Update request messages for the appropriate station pairs and date ranges. Capacity Update Request messages generated by the polling routines will not be resent if Capacity Update messages are not received from the carrier system.

In view of the foregoing description it will be evident to a person skilled in the art that various modifications may be made within the scope of the invention.

Insofar as embodiments of the invention described above are implementable, at least in part, using a software-controlled programmable processing device such as a Digital Signal Processor, microprocessor or other processing device, it will be appreciated that a computer program for configuring the programmable device to implement the foregoing described methods is envisaged as an aspect of the present invention. The computer program may be embodied as source code and undergo compilation for implementation on a processing device, or may be embodied as object code.

Suitably, the computer program is stored on a carrier medium in machine or device readable form, for example in solid-state memory or magnetic memory such as disc or tape and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

The scope of the present disclosure includes any novel feature or combination of features disclosed therein either explicitly or implicitly or any generalization thereof irrespective of whether or not it relates to the claimed invention or mitigates any or all of the problems addressed by the present invention. The applicant hereby gives notice that new claims may be formulated to such features during the prosecution of this application or of any such further application derived there from. In particular, with reference to the appended claims, features from dependent claims may be combined with those of the independent claims and features from respective independent claims may be combined in any appropriate manner and not merely in the specific combinations enumerated in the claims.

For the avoidance of doubt, the term “comprising” used in the description and claims should not be construed to mean only “consisting only of”.

What is claimed is:

1. A method of configuring a computer system including a processing unit, an interface unit for communication with said processing unit and a memory unit, for providing an integrated representation of routes in a transport system comprising a multiplicity of connectable stations, the routes being derived from data from a plurality of transport providers, the method comprising:
storing a short term schedule of individual instances of route legs each route leg corresponding to a directly connectable station pair; and
deriving a route segment table comprising one or more route segments, each route segment corresponding to an individual instance of a one of said route legs, or a combination of individual instances of said route legs, from said short term schedule.

2. A method according to claim 1, wherein said short term schedule comprises an identifier for each route leg and said deriving comprises constructing each route segment from one or more route legs having the same identifier.

3. A method according to claim 2, said short term schedule comprising data representative of an on-load permissibility at an origin station and an off-load permissibility at a destination station for each route leg instance and said deriving comprising:
reading an instance of a route leg or a combination of individual instances of route legs from the short term schedule;
checking that the route leg or route leg combination has on-load permissible at the origin station and off-load permissible at the destination station; and
including the route leg or route leg combination as a route segment in the route segment table dependent on the route leg or route leg combination having on-load permissible at the origin station and off-load permissible at the destination station.

4. A method according to claim 3, further comprising:
receiving route data from respective transport providers comprising predefined permissible origin and destination station pairs; and
storing a route table corresponding to said route data in said memory unit.

5. A method according to claim 4, further comprising:
receiving data from respective transport providers representative of one or more permissible transfer point stations between route segments for a route between an origin and destination station pair; and
storing in said memory unit a transfer set table comprising a plurality of transfer set records each associated with an origin and destination station pair, each transfer set record including one or more entries corresponding to said data representative of said permissible transfer points.

6. A method according to claim 5, said route table and/or transfer set table representing permissible route segments from permissible origin to permissible destination, from permissible origin to permissible transfer point, from permissible transfer point to permissible transfer point and/or from permissible transfer point to permissible destination and said deriving comprising:
reading an instance of a route leg or a combination of individual instances of route legs from the short term schedule;
comparing the route leg or route leg combination with the permissible route segments; and
including the route leg or route leg combination as a route segment in the route segment table dependent on the route leg or route leg combination corresponding to a permissible route segment.

7. A method according to claim 6, including in said route table or said transfer set table a parameter associated with each predefined permissible origin and destination station pair representative of a maximum number of permissible transfer points.

8. A method according to claim 7, the method further comprising:
receiving a long term schedule of route legs from respective transport providers, each route leg corresponding to a directly connectable station pair; and
forming said short term schedule from said long term schedule.

9. A method according to claim 8, the method comprising receiving said short term schedule from respective transport providers.

10. A method according to claim 9, further comprising receiving data representative of respective attributes of said route legs from said transport providers, and including data representative of one or more said attributes in said route segment table.

11. A method according to claim 10, wherein said attribute comprises a departure time and an arrival time and/or a drop-off time and a pick-up time for a journey between said connectable station pair.

12. A method according to claim 11, wherein said attribute comprises a cargo conveyance capacity between a connectable station pair.

13. A method according to claim 12, wherein said attribute further comprises a price in respect of conveyance capacity.

14. A method according to claim 13, wherein said attribute comprises a time limit for transfer of cargo between transport equipment.

15. A method according to claim 14, wherein said time limit is a minimum time.

16. A method according to claim 15, wherein said time limit is a maximum time.

17. A method according to claim 16, wherein said attribute comprises at least one cargo compatibility entry representing a characteristic of cargo compatible with the segment.

18. A method for maintaining data stored in the route segment table of a computer system, the method comprising:
receiving an update of data representative of a route leg or an attribute of a route leg from a transport provider; and
updating said data representative of said route leg or said attribute for segments in the route segment table corresponding to the route leg.

19. A method according to claim 18, further comprising initiating and sending an update request message to said transport provider.

20. A method according to claim 19, wherein said update request is a poll for a data update.

21. A method according to claim 20, further comprising re-polling for a data update at an assigned polling frequency.

22. A method according to claim 21, further comprising assigning shorter polling frequencies to earlier route segments or sets of route segments.

23. A method for maintaining data stored in a route table and/or transfer set table stored in the memory unit of a computer system, the method comprising:
receiving an update of route data and/or transfer set data from a transport provider; and
updating said route data and/or transfer set data in said route table and/or transfer set table respectively.

24. A method for operating a computer system including a processing unit, an interface unit for communication with said processing unit and a memory unit, for automatically generating route options for a transport system including a plurality of transport providers and including a multiplicity of connectable stations, wherein:
said memory unit comprises a route segment table including one or more route segments corresponding to an individual instance of a route leg, or a combination of individual instances of route legs, each said route leg corresponding to a directly connectable station pair of said transport system;
said method comprising generating one or more route options responsive to a route search request specifying a journey having an origin and destination station pair, each route option comprising a route segment having an origin and destination station pair specified in said route search request and selected from said route segment table; and
storing said one or more route options in a segment set list in said memory unit.

25. A method according to claim 24, further comprising:
comparing said requested origin and destination station pair or said one or more route options with a route table stored in said memory unit and including route data from respective transport providers comprising predefined permissible origin and destination station pairs to determine whether said requested origin and destination station pair is permissible.

26. A method according to claim 25, wherein said step of generating comprises concatenating two or more route segments to form a route option having an origin and destination station pair corresponding to said route search request.

27. A method according to claim 26, further comprising comparing said one or more route options with a transfer set table stored in said memory unit and comprising a plurality of transfer set records each associated with an origin and destination station pair, each transfer set record including one or more entries corresponding to said data representative of permissible transfer points, to determine route options having permissible route segment combinations.

28. A method according to claim 27, said generating step responsive to a route search request including a parameter representative of a maximum number of transfer points in a route between said origin and destination pair to derive route options comprising no more transfer points than said maximum number.

29. A method according to claim 28, wherein said route segment table includes one or more attributes associated with one or more route legs, the method further comprising receiving a route search request including a parameter representative of an attribute, and deriving one or more route options in dependence on said attribute.

30. A method according to claim 29, said one or more attributes comprising one or more of the following:
i) departure time and arrival time for a journey between a station pair;
ii) drop-off time and pick-up time for a journey between a station pair;
iii) a cargo conveyance capacity between a station pair;
iv) a price in respect of conveyance capacity;
v) a time limit for transfer of cargo between transport equipment; and
vi) at least one cargo compatibility entry representing a characteristic of cargo compatible with the leg or legs.

31. A method according to claim 30, wherein said generating comprises concatenating two or more route segments each having an attribute which satisfies the route search request.

32. A computer system for providing an integrated representation of routes in a transport system comprising a multiplicity of connectable stations, the routes being derived from data from a plurality of transport providers, comprising:
a processing unit;
an interface unit for communication with said processing unit; and
a memory unit;
the computer system configured to:
store a short term schedule of individual instances of route legs each route leg corresponding to a directly connectable station pair; and
derive a route segment table each route segment corresponding to an individual instance of said route legs, or combinations of individual instances of said route legs, from said short term schedule.

33. A computer system according to claim 32, wherein said short term schedule comprises an identifier for each route leg, further configured to construct each route segment from one or more route legs having the same identifier.

34. A computer system according to claim 33, wherein said short term schedule comprises data representative of an on-load permissibility at an origin station and an off-load permissibility at a destination station for each route leg instance, the system configured to:
read an instance of a route leg or a combination of individual instances of route legs from the short term schedule;
check that the route leg or route leg combination has on-load permissible at the origin station and off-load permissible at the destination station; and
include the route leg or route leg combination as a route segment in the route segment table dependent on the route leg or route leg combination having on-load permissible at the origin station and off-load permissible at the destination station.

35. A computer system according to claim 34, further configured to receive route data from said transport providers comprising predefined permissible origin and destination station pairs; and to store a route table corresponding to said route data in said memory unit.

36. A computer system according to claim 35, further configured:
to receive data from respective transport providers representative of one or more permissible transfer point stations between route segments for a route between an origin and destination station pair; and
to store in said memory unit a transfer set table comprising a plurality of transfer set records each associated with an origin and destination station pair, each transfer set record including one or more entries corresponding to said data representative of said permissible transfer points.

37. A computer system according to claim 36, wherein said route table and transfer set table represent permissible route segments from permissible origin to permissible destination, from permissible origin to permissible transfer point and from permissible transfer point to permissible designation, further configured to,
read an instance of a route leg or a combination of individual instances of route legs from the short term schedule;
compare the route leg or route leg combination with the permissible route segments; and
include the route leg or route leg combination as a route segment in the route segment table dependent on the route leg or route leg combination corresponding to a permissible route segment.

38. A computer system according to claims 37, further configured to include in said route table a parameter associated with each predefined permissible origin and destination station pair representative of a maximum number of permissible transfer points.

39. A computer system according to claim 38, further configured to:
receive a long term schedule of route legs from respective transport providers, each route leg corresponding to a directly connectable station pair; and
form said short term schedule from said long term schedule.

40. A computer system according to claim 39 further configured to:
receive said short term schedule from respective transport providers.

41. A computer system according to claim 40, further configured for receiving data representative of respective attributes of said route legs from said transport providers, and including data representative of one or more said attributes in said route segment table.

42. A computer system according to claim 41, wherein said attribute comprises a departure time and an arrival time and/or a drop-off time and a pick-up time for a journey between said connectable station pair.

43. A computer system according to claim 42, wherein said attribute comprises a cargo conveyance capacity between a connectable station pair.

44. A computer system according to claim 43, wherein said attribute further comprises a price in respect of conveyance capacity.

45. A computer system according to claim 44, wherein said attribute comprises a time limit for transfer of cargo between transport equipment.

46. A computer system according to claim 45, wherein said time limit is a minimum time.

47. A computer system according to claim 46, wherein said time limit is a maximum time.

48. A computer system according to claim 47, wherein said attribute comprises at least one cargo compatibility entry representing a characteristic of cargo compatible with the segment.

49. A computer system according to claim 48, further configured to:
receive an update of data representative of a route leg or an attribute of a route leg from a transport provider; and
update said data representative of said route leg or said attribute for segments in the route segment table corresponding to the route leg.

50. A computer system according to claim 49, further configured to initiate and send an update request message to said transport provider.

51. A computer system according to claim 50, wherein said update request is a poll for a data update.

52. A computer system according to claim 51, further configured to re-poll for a data update at an assigned polling frequency.

53. A computer system according to claim 52 further configured to assign shorter polling frequencies to route legs of earlier route segments or sets of route segments.

54. A computer system according to claim 53, further configured to:
receive an update of route data and/or transfer set data from a transport provider; and
update said route data and/or transfer set data in said route table and/or transfer set table respectively.

55. A computer system for automatically generating route options for a transport system including a multiplicity of connectable stations and a plurality of transport providers, the computer system including:
a processing unit;
an interface unit for communication with said processing unit; and
a memory unit comprising a route segment table including one or more route segments corresponding to an individual instance of a route leg, or a combination of individual instances of route legs, each said route leg corresponding to a directly connectable station pair of said transport system
the computer system configured to:
receive a route search request specifying a journey having an origin and destination pair;
generate one or more route options responsive to said route search request, each route option comprising a route segment having an origin and destination station pair specified in said route search request; and
store said one or more route options in a segment set list in said memory unit.

56. A computer system according to claim 55, further configured to compare said requested origin and destination station pair or said one or more route options with a route table stored in said memory unit and including route data from said transport providers comprising predefined permissible origin and destination station pairs to determine whether said requested origin and destination station pair is permissible.

57. A computer system according to claim 55, further configured to concatenate two or more route segments to form a route option having an origin and destination station pair corresponding to said route search request.

58. A computer system according to claim 57, further configured to compare said one or more route options with a transfer set table stored in said memory unit and comprising a plurality of transfer set records each associated with an origin and destination station pair, each transfer set record including one or more entries corresponding to said data representative of said permissible transfer points.

59. A computer system according to claim 58, configured to respond to a route search request including a parameter representative of a maximum number of transfer points in a route between said origin and destination station pair to derive route options comprising no more transfer points than said maximum number.

60. A computer system according to claim 59, wherein said route segment table includes one or more attributes associated with one or more route legs, and configured to receive a route search request including a parameter representative of an attribute, and to derive one or more route options in dependence on said attribute.

61. A computer system according to claim 60, said one or more attributes comprising one or more of the following:
i) departure time and arrival time for a journey between a station pair;
ii) drop-off time and pick-up time for a journey between a station pair;
iii) a cargo conveyance capacity between a station pair;
iv) a price in respect of conveyance capacity;
v) a time limit for transfer of cargo between transport equipment; and
vi) at least one cargo compatibility entry representing a characteristic of cargo compatible with the leg or legs.

62. A computer system according to claim 61, wherein said generating comprises concatenating two or more route segments each having an attribute which satisfies the route search request.

63. A client computer system configured for remote communication with A computer system, said client computer system comprising:
a processing unit;
an interface unit for communication with said processing unit;
a memory unit; and
a display means for displaying information to a user of said client computer system;
said processing unit comprising a user interface mechanism configured to receive a search request input via said interface unit from said user, and to communicate said search request to said computer system for processing thereby.

64. A client computer system according to claim 63, said user interface mechanism configured for providing a graphical representation of said segmentset list, said user interface mechanism operable to display on said display means a plurality of route options including origin and destination station, departure date, arrival date, available conveyance capacity and price for conveyance arranged in a logical grouping, said user interface mechanism responsive to a user input to select a displayed route option and record a user booking of at least a portion of a conveyance capacity of said selected route option.

65. A computer system network comprising a plurality of client computer systems according to claim 64 and a computer system.
